(19) United States
(12) Patent Application Publication
(10) Pub. No.: US 2019/0346982 A1
(43) Pub. Date: Nov. 14, 2019

(54) INFORMATION PROCESSING APPARATUS AND SYSTEM AND NON-TRANSITORY COMPUTER READABLE MEDIUM

(71) Applicant: FUJI XEROX CO., LTD., Tokyo (JP)

(72) Inventor: Kengo TOKUCHI, Kanagawa (JP)

(73) Assignee: FUJI XEROX CO., LTD., Tokyo (JP)

(21) Appl. No.: 16/400,171

(22) Filed: May 1, 2019

(30) Foreign Application Priority Data
May 11, 2018 (JP) 2018-092521

(51) Int. Cl. G06F 3/0485; G06F 3/0484

(52) U.S. Cl. CPC G06F 3/0485; G06F 3/0488; G06F 3/04847

(57) ABSTRACT

An information processing apparatus includes a switching unit and a receiver. The switching unit switches the entirety of a displayed image to another image when the content of a user instruction to shift the entirety of the displayed image satisfies a predetermined switching standard. The display position of the displayed image is not fixed. The receiver receives setting of the switching standard.

### CROSS-REFERENCE TO RELATED APPLICATIONS

This application is based on and claims priority under 35 USC 119 from Japanese Patent Application No. 2018-092521 filed May 11, 2018.

### BACKGROUND

### (i) Technical Field

The present disclosure relates to an information processing apparatus and system, and a non-transitory computer readable medium.

### (ii) Related Art

An electronic signage system is an example of a technology for displaying information exceeding the range of a display area. With the electronic signage system, the entirety of information, such as a character string or a drawing, exceeding the display range can be displayed by scrolling through the display surface in one direction.

In office suites (or production software), the content in the display area is continuously switched as a result of a user moving a slider.

Japanese Unexamined Patent Application Publication No. 2008-33695 is an example of the related art.

### SUMMARY

Switching of information on electronic signage is executed at predetermined intervals.

Aspects of non-limiting embodiments of the present disclosure relate to an information processing apparatus and system and a non-transitory computer readable medium that are capable of setting a standard for switching an image to be displayed.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an information processing apparatus including a switching unit and a receiver. The switching unit switches the entirety of a displayed image to another image when the content of a user instruction to shift the entirety of the displayed image satisfies a predetermined switching standard. The display position of the displayed image is not fixed. The receiver receives setting of the switching standard.

### BRIEF DESCRIPTION OF THE DRAWINGS

Exemplary embodiments of the present disclosure will be described in detail based on the following figures, wherein:

FIGS. 1A and 1B illustrate an example of an information processing apparatus according to a first exemplary embodiment;

FIG. 2 is a block diagram illustrating an example of the hardware configuration of the information processing apparatus according to the first exemplary embodiment;

FIG. 3 is a block diagram illustrating an example of the functional configuration of the information processing apparatus of the first exemplary embodiment implemented as a result of a central processing unit (CPU) executing a program;

FIG. 4 illustrates an example of the setting of a reference position (boundary) by a user;

FIGS. 5A and 5B illustrate the relationship of a specific portion of an image to a boundary;

FIG. 6 is a table illustrating examples of the standards set by a switching standard setter and used in the first exemplary embodiment;

FIGS. 7A and 7B are views for explaining the unit of display;

FIGS. 8A and 8B illustrate an example of the shifting of the display position of an image according to the first exemplary embodiment;

FIGS. 9A and 9B illustrate another example of the shifting of the display position of an image according to the first exemplary embodiment;

FIGS. 10A through 10C illustrate examples of the setting of boundaries;

FIGS. 11A and 11B illustrate an example of the shifting of the display position of an image according to a second exemplary embodiment;

FIG. 12 is a table illustrating examples of the standards set by the switching standard setter and used in the second exemplary embodiment;

FIGS. 13A and 13B illustrate another example of the shifting of the display position of an image according to the second exemplary embodiment;

FIGS. 14A and 14B illustrate an example of the shifting of the display position of an image according to a third exemplary embodiment;

FIG. 15 is a table illustrating examples of the standards set by the switching standard setter and used in the third exemplary embodiment;

FIGS. 16A and 16B illustrate another example of the shifting of the display position of an image according to the third exemplary embodiment;

FIGS. 17A through 17C illustrate an example of the shifting of the display position of an image according to a fourth exemplary embodiment;

FIG. 18 illustrates an example of the setting of boundaries according to a fifth exemplary embodiment;

FIG. 19 illustrates another example of the setting of boundaries according to the fifth exemplary embodiment;

FIG. 20 illustrates another example of the setting of boundaries according to the fifth exemplary embodiment;

FIGS. 21A and 21B illustrate an information processing apparatus including a body formed in a cuboid shape and four display surfaces disposed continuously on the peripheral surface of the body according to a sixth exemplary embodiment;

FIG. 22 illustrates an information processing apparatus including a body formed in a spherical shape and a display surface disposed on the surface of the body according to a seventh exemplary embodiment;

FIG. 23 illustrates an example in which a spherical display surface is divided into an upper-hemisphere partial display surface and a lower-hemisphere partial display surface;

FIG. 24 illustrates an example of a technique for informing a user that image switching will soon occur according to an eighth exemplary embodiment;

FIGS. 25A through 25C illustrate the schematic configuration of an information processing apparatus which forms an aerial image in the air according to a ninth exemplary embodiment;

FIGS. 26A and 26B are views for explaining how an aerial image forming device forms an aerial image;

FIG. 27 is a view for explaining how an aerial image forming device forms a three-dimensional image as an aerial image;

FIGS. 28A and 28B are views for explaining how an aerial image forming device forms an aerial image by using a micromirror array;

FIG. 29 is a view for explaining how an aerial image forming device forms an aerial image by using a beam splitter and a retroreflective sheet;

FIG. 30 is a view for explaining how an aerial image forming device forms a set of plasma emitting members as an aerial image;

FIGS. 31A and 31B illustrate a technique for setting a print area on a 360°-continuous display surface according to a tenth exemplary embodiment;

FIG. 32 illustrates examples of functions implemented as a result of a CPU executing a program;

FIGS. 33A and 33B illustrate an example of the execution of printing when one edge portion is set and the print direction is leftward (clockwise);

FIGS. 34A and 34B illustrate an example of the execution of printing when two edge portions are set and the print direction is rightward (counterclockwise);

FIGS. 35A and 35B illustrate an example in which the print direction is automatically determined according to the content of a displayed image;

FIGS. 36A and 36B illustrate an example of the execution of printing when display areas of a display surface are distinguishable from each other from the physical shape of the display surface; and

FIGS. 37A and 37B illustrate another example of the execution of printing when display areas of a display surface are distinguishable from each other from the physical shape of the display surface.

### DETAILED DESCRIPTION

Exemplary embodiments of the disclosure will be described below with reference to the accompanying drawings.

### First Exemplary Embodiment

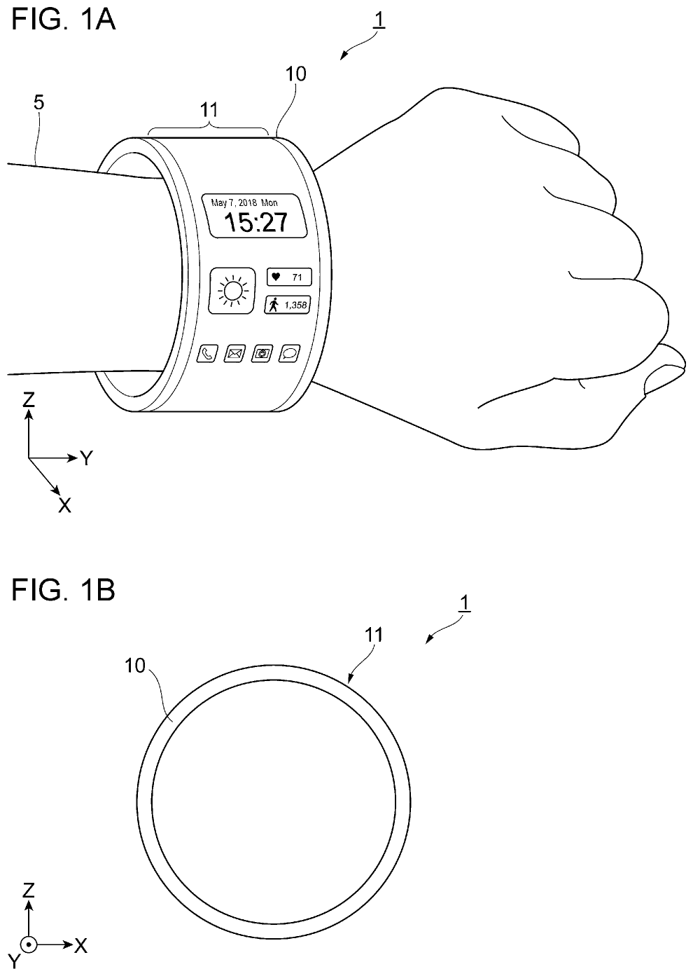

FIGS. 1A and 1B illustrate an example of an information processing apparatus 1 according to a first exemplary embodiment. FIG. 1A shows how the information processing apparatus 1 can be used. FIG. 1B is a side view of the information processing apparatus 1.

The information processing apparatus 1 shown in FIG. 1A is worn on an arm 5 of a user.

In the first exemplary embodiment, the information processing apparatus 1 includes a cylindrical body 10 and a display surface 11. The display surface 11 is disposed all along the outer peripheral surface of the body 10. That is, the display surface 11 is an example of a 360° display. In other words, the display surface 11 has a curved shape.

The display surface 11 is physically continuous by 360°. However, the display surface 11 may be constituted by a set of plural display devices, provided that it can be used almost in the same manner as the 360°-continuous display surface 11.

In the first exemplary embodiment, the maximum display area of the display surface 11 is the area defined by the entire circumference and the entire width. That is, the entirety of the area of the display surface 11 that a user can view is the maximum range of the area used for displaying information.

In the following description, the display area is the entirety of the display surface 11, unless otherwise stated.

In the first exemplary embodiment, the display surface 11 is constituted by a panel, such as an organic electroluminescence (EL) panel or a liquid crystal panel. On the display surface 11 shown in FIG. 1A, various items of information, such as those about the weather, time, heart rate, and daily steps, and functional buttons for email and telephone, for example, are disposed. Not only still images, but also video images may be displayed on the display surface 11.

Other information may be displayed on the display surface 11. For example, values output from various sensors integrated in the body 10 may be displayed, information received from an external source via a communication function may be displayed, and information read from a storage device, which is not shown, may also be displayed.

In the first exemplary embodiment, the body 10 is formed in a cylindrical shape. However, the body 10 may have a separated portion at a mid-position of the circumferential surface, so that the user can wear it on the arm 5 or remove it by opening the ends of the separated portion. A certain fixture (not shown), such as a buckle, may be attached to the ends of the separated portion. The body 10 may be a band-like member made of an elastic material.

In the first exemplary embodiment, the display surface 11 is attached to the body 10 so that it can be continuous by 360° when the body 10 is worn on the arm 5. Alternatively, the display surface 11 may have a gap in the circumferential direction so that it becomes discontinuous when the body 10 is worn on the arm 5. For example, the display surface 11 may be continuous by 350°, 300°, 180°, or 120° in the circumferential direction.

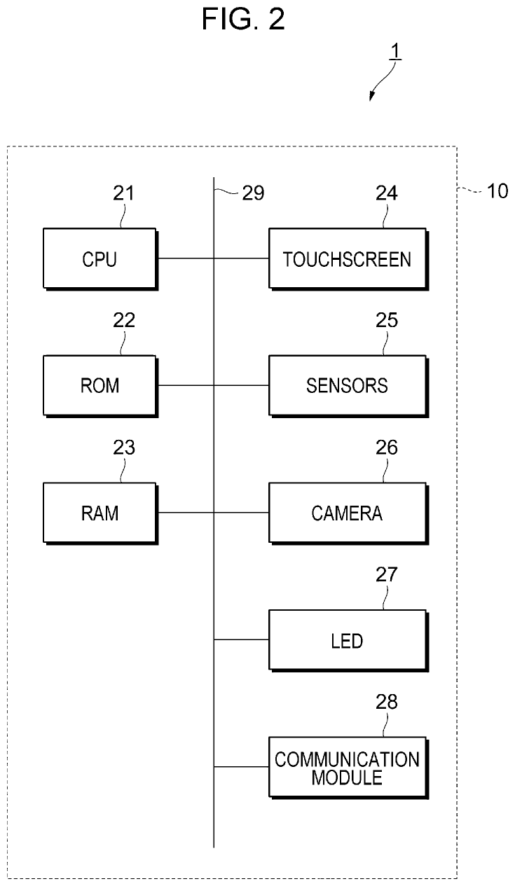

FIG. 2 is a block diagram illustrating an example of the hardware configuration of the information processing apparatus 1 according to the first exemplary embodiment.

The body 10 includes a central processing unit (CPU) 21, a read only memory (ROM) 22, and a random access memory (RAM) 23. The CPU 21 controls the entirety of the information processing apparatus 1 as a result of executing a program (including firmware). The ROM 22 stores programs, such as basic input output system (BIOS) and firmware. The RAM 23 is used as a work area for programs.

The CPU 21, the ROM 22, and the RAM 23 function as a computer and execute various information processing operations. The ROM 22 is constituted by a non-volatile semiconductor memory.

The body 10 also includes a touchscreen 24, sensors 25, a camera 26, a light-emitting diode (LED) 27, and a communication module 28. The touchscreen 24 forms the display surface 11 (see FIGS. 1A and 1B). The sensors 25 output a physical quantity of a subject as an electric signal. The camera 26 captures an image of a subject. The LED 27 serves as a light source. The communication module 28 is used for communicating with an external device. These elements are connected to each other via a bus 29.

On the touchscreen 24, an operation detection device and a display device are provided. The operation detection device detects the position of a subject, such as a user's fingertip, on the display surface 11. The display device is constituted by an organic EL panel or a liquid crystal panel and is used for displaying information.

The sensors 25 include an atmospheric temperature sensor, a body temperature sensor, a pulse rate sensor, an acceleration sensor, a gyro sensor, a magnetic sensor, a global positioning system (GPS) sensor, an ambient light sensor, a proximity sensor, and a fingerprint sensor, for example. Output from the acceleration sensor is used for measuring the number of steps a user has walked, for example. The sensors 25 may not necessarily include all of the above-described sensors, and may include only some of them.

The communication module 28 includes, for example, a wireless fidelity (WiFi) (registered trademark) module that sends and receives wireless signals compliant with the WiFi standard and a Bluetooth (registered trademark) module that sends and receives wireless signals compliant with the Bluetooth standard, which is one of the near field communication standards.

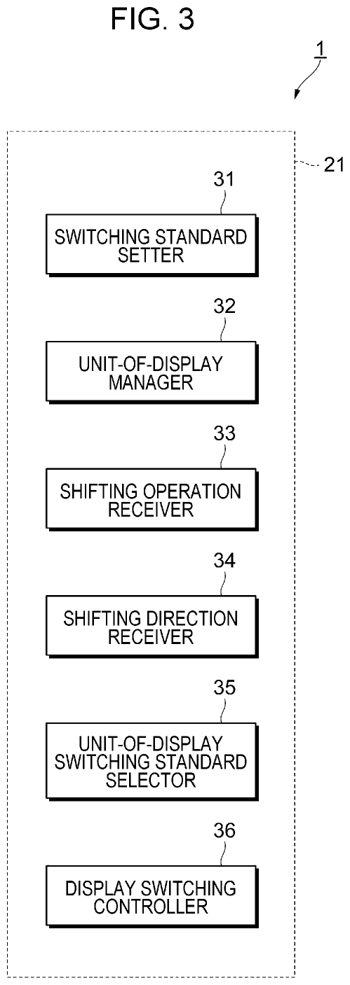

FIG. 3 is a block diagram illustrating an example of the functional configuration implemented as result of the CPU 21 executing a program.

The functional configuration shown in FIG. 3 is a configuration limited to the following image switching function. The image switching function is a function of shifting the entirety of an image displayed on the display surface 11 (see FIGS. 1A and 1B) in response to a user instruction while maintaining the identity of the image.

Maintaining the identity of an image refers to that the content of a displayed image remains the same even if the position of the displayed image within the display surface 11 is changed.

Images displayed at fixed positions on the display surface 11 are excluded from subjects of this function. In other words, all images that are movably displayed on the display surface 11 are subjects to be shifted within the display surface 11 by using this function. Icons and times located along the edge of the display of a smartphone or a computer are examples of the images displayed at fixed positions on the display surface 11. Changing the display positions of these icons and times does not maintain their identities and is thus different from shifting of an image by using this function in the first exemplary embodiment.

Maintaining the identity of an image refers to a state in which, if an image displayed on the display surface 11 is a still image, no excess or no shortage occurs to elements forming the image on the display surface 11. An excess of the elements forming the image means that a new element is added as a result of shifting the image. A shortage of the elements forming the image means that an element included in the image is eliminated as a result of shifting the image.

Maintaining the identity of an image refers to a state in which, if part of an image displayed on the display surface 11 is a video image, no excess or no shortage occurs to elements forming the image on the display surface 11, except for the video image.

If the entirety of an image displayed on the display surface 11 is a video image, maintaining the identity of an image refers to a state in which the content of the displayed image remains the same even if the display position of the image is changed.

Maintaining the identity of an image is also applied to a case involving changing of a layout, for example, in which an image is enlarged in a specific area of the display surface 11.

In the first exemplary embodiment, an image being shifted while maintaining its identity is not limited to an image displayed in the entire area of the display surface 11 (see FIGS. 1A and 1B), but may also be an image displayed in part of the display area of the display surface 11. In this case, a user may select which portion of the display area to be shifted. Or, such a portion may be determined in advance or may automatically be set.

In other words, shifting of an image while maintaining its identity refers to that the display position of an image is changed in such a manner that the entirety of the image is cyclically shifted or rotated within a predetermined area of the display surface 11 in a shifting direction selected by a user. Rotation is one mode of cyclic shifting. The predetermined area of the display surface 11 may be the entirety or part of the display surface 11.

Cyclic shifting refers to a state in which, in response to an instruction to shift an image toward an end portion of the display surface 11 (toward the opening in FIGS. 1A and 1B), the image positioned at one end portion disappears outside the display surface 11 and appears again from the other end portion of the display surface 11.

Accordingly, for example, displaying a character string exceeding a display range by scrolling through the display surface, such as in electronic signage, is not a case in which an image is shifted while maintaining its identity.

In the case of document creation software of office suites (or production software), new information appears on the screen from a side on which a slider is moved, and information displayed on the opposite side disappears from the screen. Accordingly, this is not a case in which an image is shifted while maintaining its identity.

The reason why the cyclic displaying function is provided in the first exemplary embodiment is that part of the cylindrical display surface 11 is not physically seen from a user. The user is able to see the entirety of an image displayed on the display surface 11 by rotating the position of the image in the circumferential direction.

The user may alternatively rotate the body 10 (see FIGS. 1A and 1B) around the arm 5, but this is not always feasible. As in the first exemplary embodiment, the function of rotating only the display position is useful in terms of viewing the entirety of an image.

The CPU 21 shown in FIG. 3 serves as a switching standard setter 31, a unit-of-display manager 32, a shifting operation receiver 33, a shifting direction receiver 34, a unit-of-display switching standard selector 35, and a display switching controller 36. The switching standard setter 31 sets a standard for switching the entirety of an image which is shifting while maintaining its identity to another image. The unit-of-display manager 32 manages an image to be shifted while maintaining its identity. That is, the unit-of-display manager 32 manages the unit of display. The shifting operation receiver 33 receives a shifting operation from a user. The shifting direction receiver 34 receives the direction of a shifting operation from a user. The unit-of-display switching standard selector 35 selects a standard concerning how an image, which is a unit of display, will be shifted or switched. The display switching controller 36 controls the switching of an image to be displayed, based on the selection result supplied from the unit-of-display switching standard selector 35.

In the first exemplary embodiment, the unit of display corresponds to an image displayed on the maximum display area of the display surface 11, and is also a unit by which an image is switched, as stated above.

If part of the maximum display area of the display surface 11 is secured for specific images, such as operation buttons, the unit of display is determined as an image displayed in the area except for an area secured for such specific images.

The switching standard setter 31 sets a standard for determining whether image switching will be performed, based on a combination of the shifting direction of an image and the relationship of a specific portion of the image to a reference position (boundary).

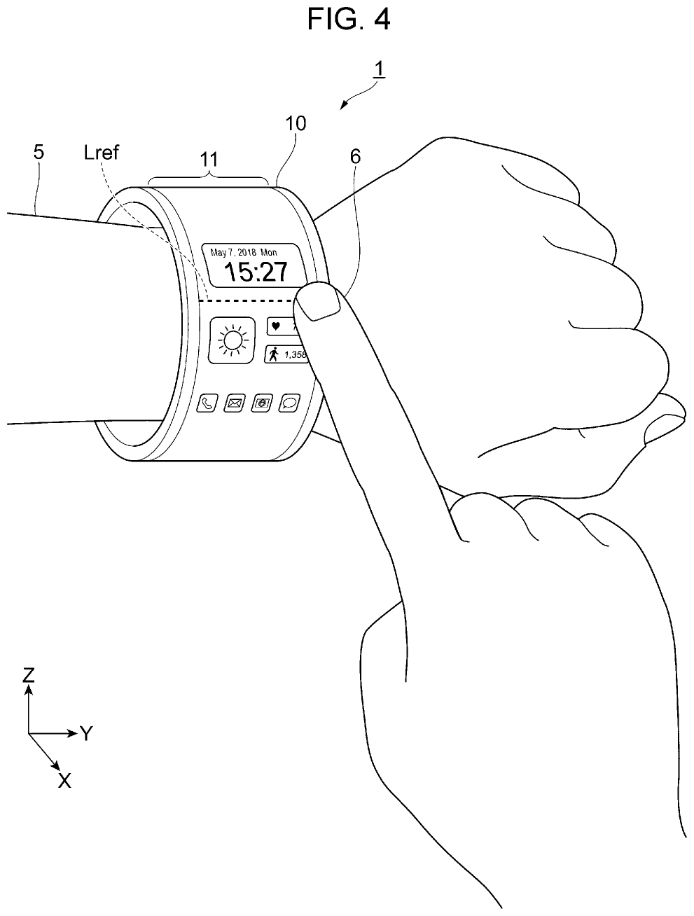

FIG. 4 illustrates an example of the setting of a reference position (boundary) by a user.

In FIG. 4, elements corresponding to those in FIGS. 1A and 1B are designated by like reference numerals. In FIG. 4, a boundary Lref is set on the display surface 11 in parallel with the axial direction of the cylindrical body 10.

The boundary Lref shown in FIG. 4 is used for determining whether an image will be switched in response to the shifting of the image in the circumferential direction.

In FIG. 4, the boundary Lref is set as a line from the left side to the right side (in the widthwise direction) of the display surface 11. However, a mere position on the circumference of the display surface 11 is sufficient to set the boundary Lref. Accordingly, a dot or a symbol, for example, may alternatively be used for setting the boundary Lref.

In the first exemplary embodiment, an image is switched to another image on condition that a specific portion of the image crosses over the boundary Lref in a predetermined direction.

It is thus desirable that the boundary Lref be set at a position at which it does not prevent a user from viewing an image. For example, the display position of an image that a user frequently views is more likely to be changed than other images. If such an image is switched while the user is viewing it, the user-friendliness is impaired.

It is thus desirable that the boundary Lref be set according to the content of an image displayed on the display surface 11.

In FIG. 4, a user has selected a position of the boundary Lref by using a fingertip 6. More specifically, the boundary Lref is set at a position between the images indicating the weather, heart rate, and daily steps and the image indicating the time and date. Icons for the weather, daily steps, time and date, and so on, are used for executing a certain application or informing a user of the current state.

If a document or an image is displayed on the display surface 11, it is desirable that the boundary Lref be set by avoiding an area for displaying such a document or an image.

The boundary Lref may be set at a specific position of the display surface 11 regardless of the content of an image displayed on the display surface 11. For example, in the case of the cylindrical display surface 11, both end portions of the display surface 11 close to the opening may be set as the boundaries Lref for shifting an image in the axial direction.

If options of positions that may be used as the boundary Lref are provided in advance, one of the options may be selected as the boundary Lref.

The displaying of the boundary Lref may be restricted to the occasion when setting the boundary Lref. Alternatively, the boundary Lref may not necessarily be displayed even when it is set.

However, if the boundary Lref is not displayed after an image has started to move on the display surface 11, the positional relationship of the image to the boundary Lref may become unclear. It is thus desirable that even after the image has started to move, the boundary Lref be displayed in a certain manner. For example, the boundary Lref may be indicated by a broken line. Or, the boundary Lref may be displayed at a portion without any objects or with few objects so that a user is not prevented from checking the image.

Upon setting the boundary Lref, a specific portion of an image is also determined.

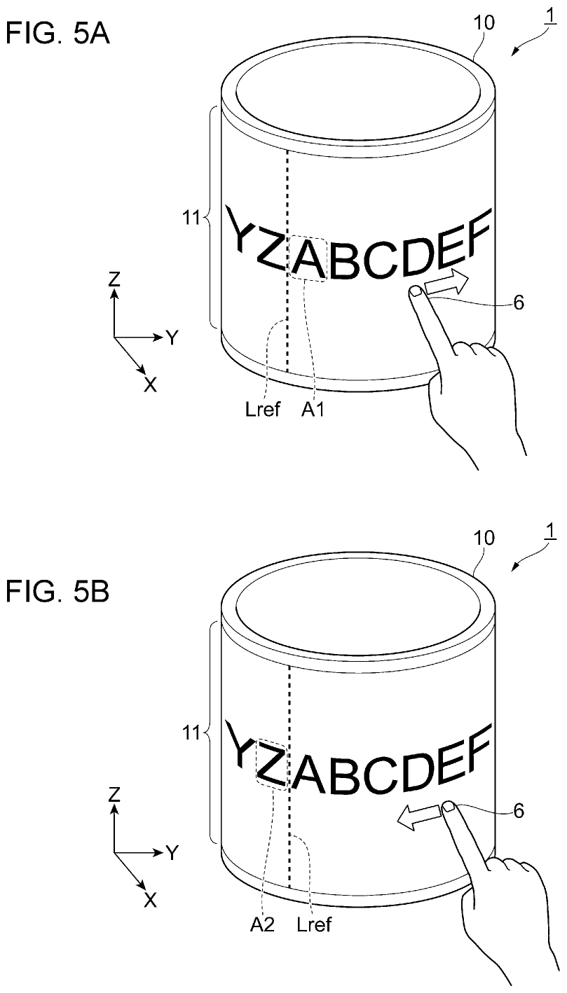

FIGS. 5A and 5B illustrate the relationship of a specific portion of an image to the boundary Lref. FIG. 5A shows an example of a specific portion which is set for the shifting of the image in the rightward direction (counterclockwise). FIG. 5B shows an example of a specific portion which is set for the shifting of the image in the leftward direction (clockwise).

In FIGS. 5A and 5B, the character string “ABC . . . YZ” is displayed along the circumference of the display surface 11. The boundary Lref is set at a position between the alphabetic character “A” and the alphabetic character “Z”.

In this case, the character “A” displayed next to the boundary Lref on the right side is selected as a specific portion A1. The specific portion A1 is used for determining whether image switching will be performed in response to the shifting in the rightward direction (counterclockwise). The character “Z” displayed next to the boundary Lref on the left side is selected as a specific portion A2. The specific portion A2 is used for determining whether image switching will be performed in response to the shifting in the leftward direction (clockwise).

In FIGS. 5A and 5B, characters are used as specific portions. However, an icon or an object, for example, may alternatively be selected as a specific portion.

The specific portion may be determined regardless of the content of an image. For example, an area for N pixels (N is a natural number other than 0) from the boundary Lref in the rightward direction (counterclockwise) or in the leftward direction (clockwise) may be set as a specific portion. In this case, the number of pixels may be changed according to whether the shifting direction is rightward (counterclockwise) or leftward (clockwise) with respect to the boundary Lref.

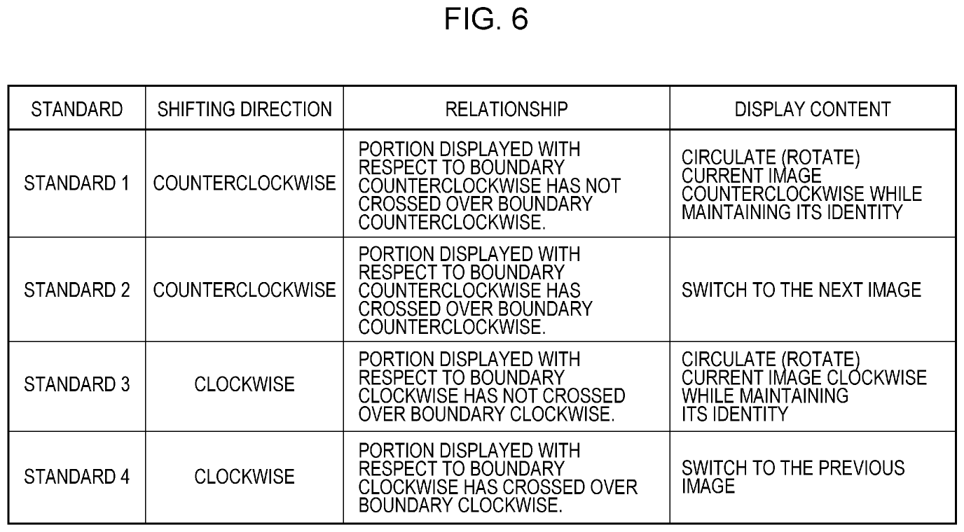

FIG. 6 is a table illustrating examples of the standards set by the switching standard setter 31 (see FIG. 3) and used in the first exemplary embodiment. The standards shown in FIG. 6 are applicable only when one boundary Lref is set on the display surface 11.

Standard 1 and standard 2 are standards used for image switching when the shifting direction is the rightward direction (counterclockwise). Standard 3 and standard 4 are standards used for image switching when the shifting direction is the leftward direction (clockwise).

The difference between standard 1 and standard 2 is whether or not a specific portion (character “A” in FIG. 5A, for example) has crossed over the boundary Lref in the counterclockwise direction.

While the specific portion has not crossed over the boundary Lref (when the relationship of the specific portion to the boundary Lref satisfies standard 1), image switching is not performed. That is, a currently displayed image is circulated (rotated) counterclockwise while being continuously displayed.

If the specific portion has crossed over the boundary Lref (when the relationship of the specific portion to the boundary Lref satisfies standard 2), image switching is performed. In the first exemplary embodiment, the currently displayed image is switched to the next image.

The difference between standard 3 and standard 4 is whether or not a specific portion (character “Z” in FIG. 5B, for example) has crossed over the boundary Lref in the clockwise direction.

While the specific portion has not crossed over the boundary Lref (when the relationship of the specific portion to the boundary Lref satisfies standard 3), image switching is not performed. That is, a currently displayed image is circulated (rotated) clockwise while being continuously displayed.

If the specific portion has crossed over the boundary Lref (when the relationship of the specific portion to the boundary Lref satisfies standard 4), image switching is performed. In the first exemplary embodiment, the currently displayed image is switched to the previous image.

Referring back to a description with reference to FIG. 3, the unit-of-display manager 32 manages, for example, the relationship between an image (unit of display) which is currently displayed on the display surface 11 and an image (unit of display) which will be displayed after a switching operation. For example, the unit-of-display manager 32 manages the relationship concerning the display order of images, such as an image to be displayed next and an image to be displayed after next.

The unit-of-display manager 32 may manage the above-described relationship according to the shifting direction. For example, the unit-of-display manager 32 may vary the unit of display according to the shifting direction. In the example in FIGS. 1A and 1B, the unit-of-display manager 32 may vary a group of images to be displayed (unit of display) according to whether the shifting operation is performed in the direction toward the end portions of the cylindrical body 10 (toward the opening) or in the direction substantially perpendicular to the direction toward the end portions (360°-rotating direction).

The shifting operation receiver 33 receives, among operations performed by a user on the touchscreen 24 (see FIG. 2), an operation that can be regarded as a shifting instruction.

In the first exemplary embodiment, tapping on the display surface 11 in a specific direction with a fingertip, flicking the display surface 11 in a specific direction with a fingertip, and sliding a fingertip over the display surface 11 while holding it in contact with the display surface 11 are all regarded as shifting instructions.

The shifting direction receiver 34 receives, as the shifting direction, the direction in which an operation received as a shifting instruction has been performed. In the example in FIGS. 1A and 1B, the shifting direction receiver 34 receives the shifting direction by detecting whether the direction of the shifting operation performed on the information processing apparatus 1 worn on the arm 5 is upward along the display surface 11, downward along the display surface 11, rightward toward the opening, or leftward toward the opening.

The shifting direction may include an oblique direction. The oblique direction may be divided into two components, that is, one component in the direction substantially perpendicular to the end portions of the display surface 11 and the other component in the direction toward the end portions.

The unit-of-display switching standard selector 35 selects a switching standard representing how an image (unit of display) will be shifted or switched in accordance with a shifting operation in a specific direction, and supplies a selection result to the display switching controller 36.

The display switching controller 36 performs control so that an image will be switched based on the selection result. In this case, the control operation executed by the display switching controller 36 includes, not only switching of an image as the unit of display, but also shifting of the position of an image displayed as the unit of display within the display surface 11.

The display switching controller 36 is an example of a switching unit that switches the entirety of an image displayed on the display surface 11 to another image.

### (Display Examples)

Shifting and switching of images using the above-described function will be described below.

### (Unit of Display)

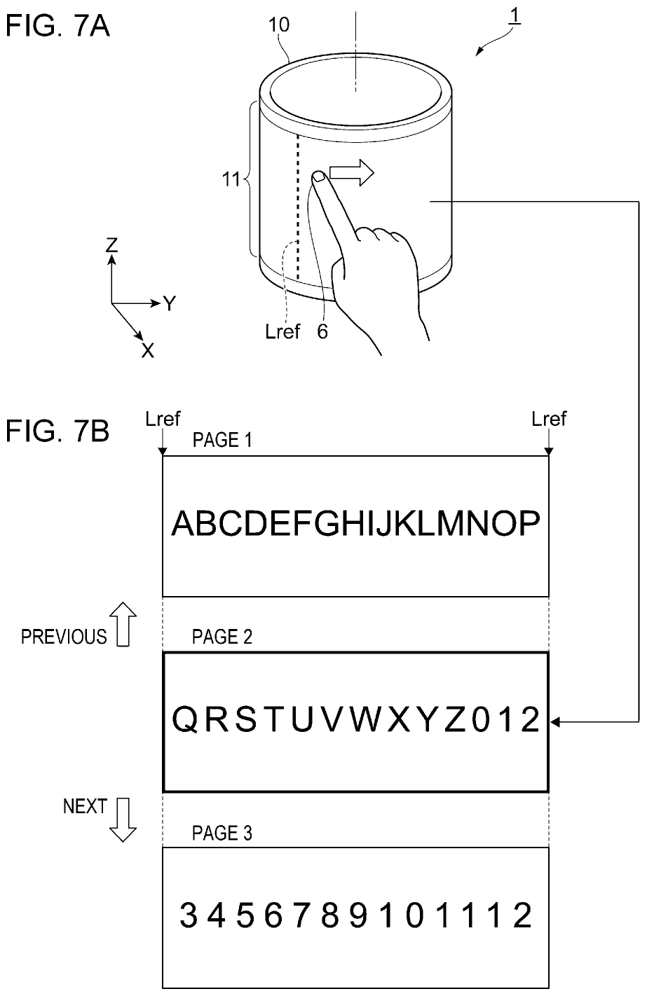

FIGS. 7A and 7B are views for explaining the unit of display. FIG. 7A shows a user operation performed on the information processing apparatus 1. FIG. 7B shows examples of images, each of which forms the unit of display, at different times.

In FIG. 7A, the user moves a fingertip 6 in the rightward direction (counterclockwise) along the circumference of the display surface 11. The shifting direction of the fingertip 6 is indicated by the arrow in FIG. 7A.

The shifting direction in FIG. 7A is the circumferential direction. An image serving as the unit of display on the display surface 11 is thus shifted in the rightward direction (counterclockwise) by the distance by which the user has moved the fingertip 6.

In FIG. 7B, three images are shown as the unit of display by way of example. In FIGS. 7A and 7B, the unit of display is managed by page.

In FIG. 7B, the display surface 11 is displayed as a result of being cut at the reference position (boundary Lref) shown in FIG. 7A. The same arrow is indicated at both edges of the images in FIG. 7B.

Page 1 is constituted by a character string “ABCDEFGHIJKLMNOP” disposed along the circumferential direction.

Page 2 is constituted by a character string “QRSTUVWXYZ012” disposed along the circumferential direction.

Page 3 is constituted by a character string “3456789101112” disposed along the circumferential direction.

The current unit of display is page 2. The previous page is page 1, and the next page is page 3.

### (First Display Example)

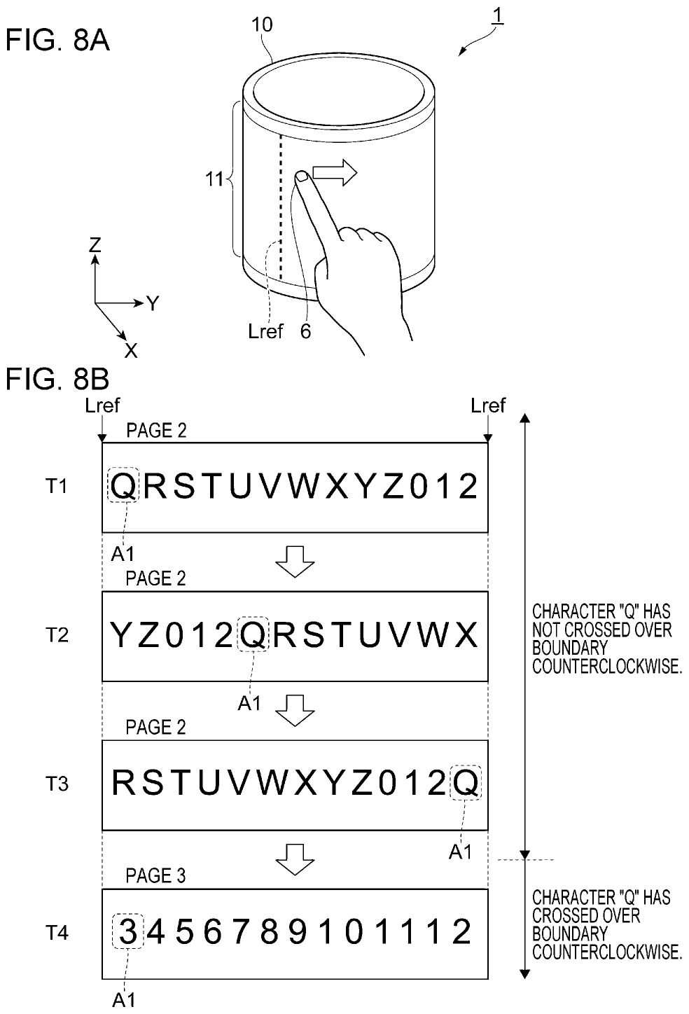

FIGS. 8A and 8B illustrate an example of the shifting of the display position of an image according to the first exemplary embodiment. FIG. 8A shows a user operation performed on the information processing apparatus 1. FIG. 8B shows the transition of displayed images in response to a shifting operation.

In FIGS. 8A and 8B, as well as in FIGS. 7A and 7B, the display surface 11 is displayed as a result of being cut at the reference position (boundary Lref).

At time T1, page 2 is displayed as the unit of display. At time T1, a user has not yet provided a shifting instruction. In this case, the character string “QRSTUVWXYZ012” is displayed in this order in the rightward direction (counterclockwise) from the left-side reference position (boundary Lref).

At time T2, the user has moved the fingertip 6 in the rightward direction (counterclockwise), and the arrangement of the character string displayed on the display surface 11 is indicated. At time T2, the position of the image is shifted in the rightward direction by five characters with respect to that at time T1. The character string “YZ012QRSTUVWX” is displayed on the display surface 11 in this order in the rightward direction from the left-side reference position (boundary Lref).

At time T3, the user has moved the fingertip 6 further in the rightward direction (counterclockwise), and the arrangement of the character string displayed on the display surface 11 is indicated. At time T3, the position of the image is shifted in the rightward direction by seven characters with respect to that at time T2. The character string “RSTUVWXYZ012Q” is displayed on the display surface 11 in this order in the rightward direction from the left-side reference position.

That is, the character “Q” located at the head of the character string in the rightward direction (counterclockwise) as viewed from the left-side reference position (boundary Lref) at time T1 is located at the tail of the character string at time T3.

In this state, if the user moves the fingertip 6 in the rightward direction (counterclockwise), the character “Q”, which is a specific portion A1, will cross over the boundary Lref in the rightward direction (counterclockwise).

At time T4, the arrangement of the character string after the image displayed on the display surface 11 has changed from page 2 to page 3 is indicated.

In this manner, while the character “Q”, which is the specific portion A1, has not crossed over the boundary Lref in the rightward direction (counterclockwise) after an image has been shifted in the rightward direction (counterclockwise) in response to a user operation, page 2, which forms the unit of display, is merely shifted along the display surface 11 in the shifting direction. However, when the display position of page 2 is rotated through one revolution, that is, when the character “Q”, which is the specific portion A1, has crossed over the boundary Lref in the rightward direction (counterclockwise), page 2 is switched to the next image, that is, page 3.

### (Second Display Example)

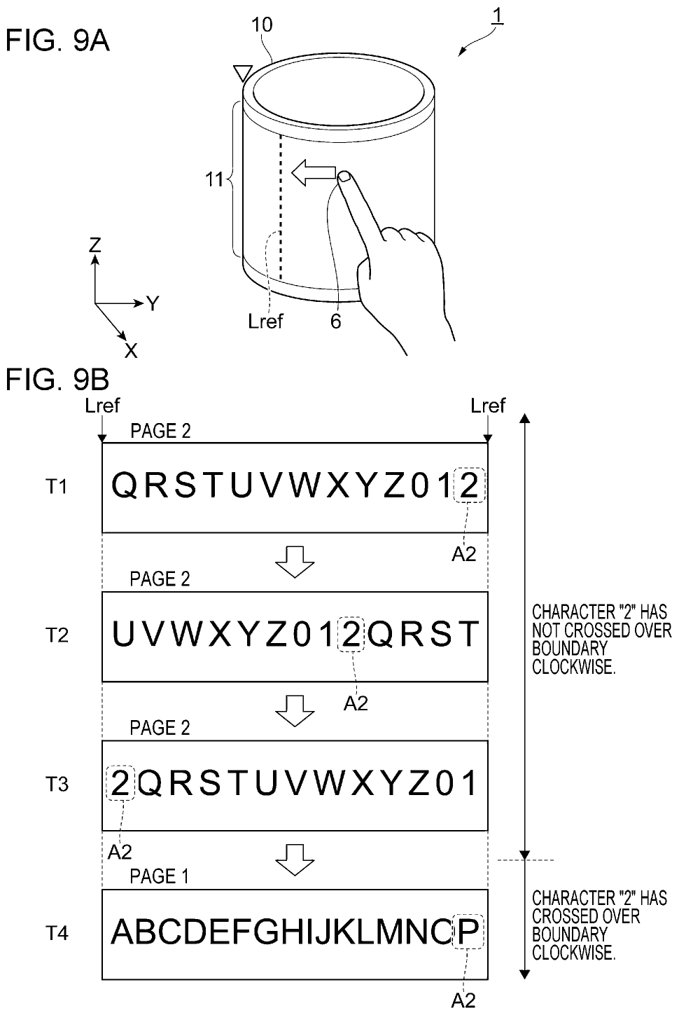

FIGS. 9A and 9B illustrate another example of the shifting of the display position of an image according to the first exemplary embodiment. FIG. 9A shows a user operation performed on the information processing apparatus 1. FIG. 9B shows the transition of displayed images in response to a shifting operation.

In FIGS. 9A and 9B, as well as in FIGS. 8A and 8B, the display surface 11 is displayed as a result of being cut at the reference position (boundary Lref).

The image displayed at time T1 is the same image in the first display example (see FIG. 8B). That is, page 2, which forms the unit of display, is displayed on the display surface 11. The character string “QRSTUVWXYZ012” is displayed in this order in the rightward direction (counterclockwise) from the left-side reference position.

At time T2, the user has moved the fingertip 6 in the leftward direction (clockwise), and the arrangement of the character string displayed on the display surface 11 is indicated. At time T2, the position of the image is shifted in the leftward direction by four characters with respect to that at time T1. The character string “UVWXYZ012QRST” is displayed on the display surface 11 in this order in the rightward direction from the left-side reference position (boundary Lref).

At time T3, the user has moved the fingertip 6 further in the leftward direction (clockwise), and the arrangement of the character string displayed on the display surface 11 is indicated. At time T3, the position of the image is shifted in the leftward direction by eight characters with respect to that at time T2. The character string “2QRSTUVWXYZ01” is displayed on the display surface 11 in this order in the rightward direction from the left-side reference position (boundary Lref).

That is, the character “2” located at the head of the character string in the leftward direction (clockwise) as viewed from the right-side reference position (boundary Lref) at time T1 is located at the tail of the character string at time T3.

In this state, if the user moves the fingertip 6 in the leftward direction (clockwise), the character “2”, which is a specific portion A2, will cross over the boundary Lref in the leftward direction (clockwise).

At time T4, the arrangement of the character string after the image displayed on the display surface 11 has changed from page 2 to page 1 is indicated.

In this manner, while the character “2”, which is the specific portion A2, has not crossed over the boundary Lref in the leftward direction (clockwise) after an image has been shifted in the leftward direction (clockwise) in response to a user operation, page 2, which forms the unit of display, is merely shifted along the display surface 11 in the shifting direction. However, when the display position of page 2 is rotated through one revolution, that is, when the character “2”, which is the specific portion A2, has crossed over the boundary Lref in the leftward direction (clockwise), page 2 is switched to the previous image, that is, page 1.

### MODIFIED EXAMPLE

In the above-described examples, the reference position (boundary Lref) used for determining whether image switching will be performed is set in parallel with the axial direction of the cylindrical display surface 11. However, the reference position (boundary Lref) may be set in a different manner.

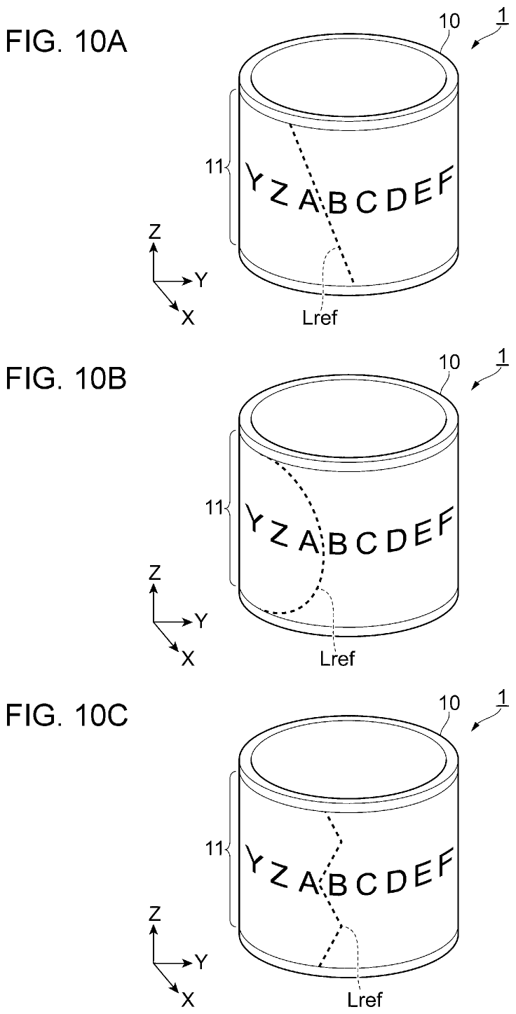

FIGS. 10A through 10C illustrate other examples of the setting of the boundary Lref. In FIG. 10A, the boundary Lref is set in the oblique direction with respect to the display surface 11. In FIG. 10B, the boundary Lref is set as a curve on the display surface 11. In FIG. 10C, the boundary Lref is set as a zigzag line on the display surface 11.

The boundaries Lref shown in FIGS. 10A through 10C are only examples. The boundary Lref may be set as a combination of a straight line and a curve.

### Second Exemplary Embodiment

In a second exemplary embodiment, the direction of a shifting operation is the axial direction of the cylindrical display surface 11.

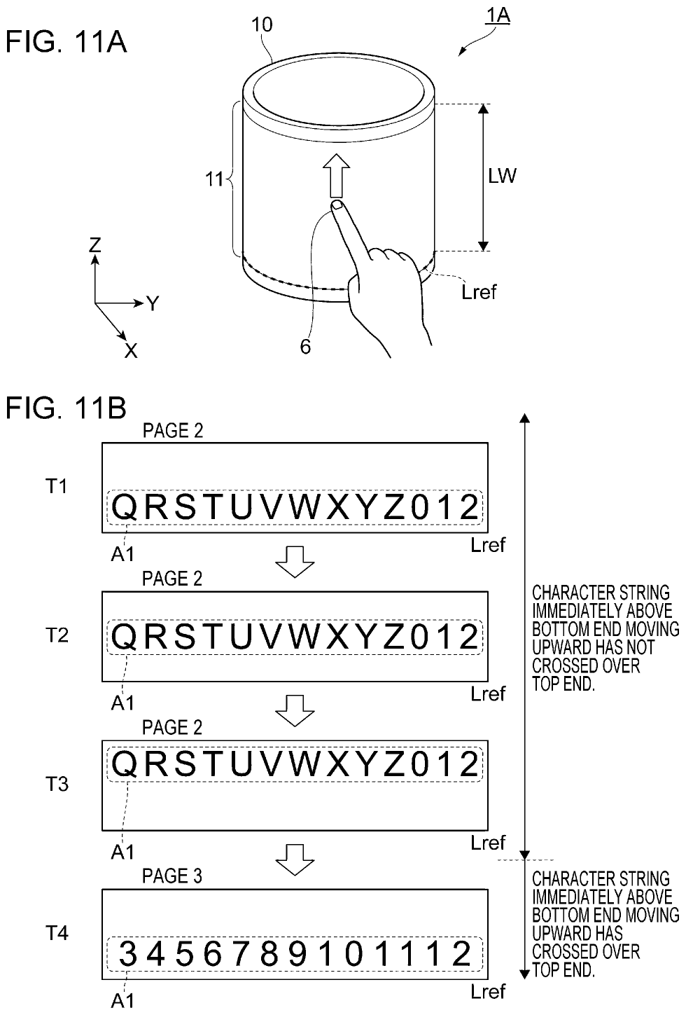

FIGS. 11A and 11B illustrate an example of the shifting of the display position of an image according to the second exemplary embodiment. FIG. 11A shows a user operation performed on an information processing apparatus 1A. FIG. 11B shows the transition of displayed images in response to a shifting operation.

In FIGS. 11A and 11B, elements corresponding to those in FIGS. 8A and 8B are designated by like reference numerals. In FIG. 11A, the width of the display surface 11 in the axial direction is indicated by LW.

The hardware configuration and the functional configuration of the information processing apparatus 1A shown in FIGS. 11A and 11B are similar to those of the information processing apparatus 1 (see FIGS. 2 and 3).

In the second exemplary embodiment, one of the two end portions which define the outer edges of the display surface 11 is set as the reference position (boundary) in a shifting direction.

In FIGS. 11A and 11B, the bottom end of the display surface 11 is set as the boundary Lref. The top end of the display surface 11 may alternatively be set as the boundary Lref. Or, the boundary Lref may be set at an intermediate position (between the top and bottom ends) of the display surface 11.

The boundary Lref may be set by a user or may have been set in advance.

In the second exemplary embodiment, as well as in the first exemplary embodiment, the image reached one end portion of the display surface 11 in response to an instruction disappears outside the display surface 11 and appears again from the other end portion. That is, an image is cyclically shifted on the display surface 11 while maintaining its identity.

In FIGS. 11A and 11B, the image is shifted from the bottom end to the top end.

At time T1, page 2 is displayed as the unit of display. At time T1, a user has not yet provided a shifting instruction.

In this case, the character string “QRSTUVWXYZ012” is displayed immediately above the bottom end (that is, the boundary Lref).

For the sake of representation, the head of the character string is “Q”. In the second exemplary embodiment, the character string “QRSTUVWXYZ012” positioned at the bottom section is used as the specific portion A1 for the upward shifting.

At time T2, the user has moved the fingertip 6 in the upward direction, and the arrangement of the character string displayed on the display surface 11 is indicated. At time T2, the character string “QRSTUVWXYZ012” is moved to the middle section of the display surface 11.

At time T3, the user has moved the fingertip 6 further in the upward direction, and the arrangement of the character string displayed on the display surface 11 is indicated. At time T3, the character string “QRSTUVWXYZ012” is moved to the top section of the display surface 11.

At time T4, as a result of the user moving the fingertip 6 further in the upward direction, the image displayed on the display surface 11 has changed from page 2 to page 3.

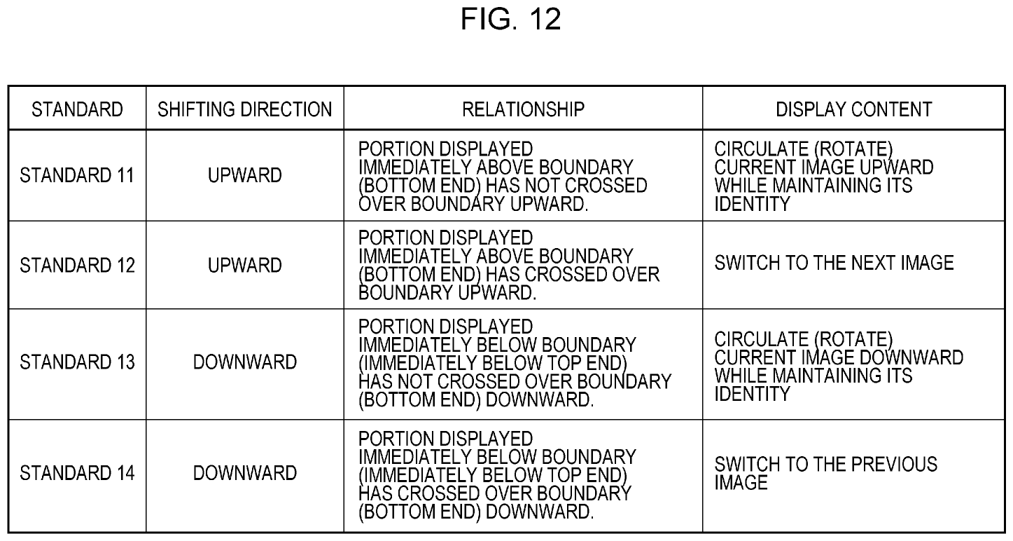

FIG. 12 is a table illustrating examples of the standards set by the switching standard setter 31 (see FIG. 3) and used in the second exemplary embodiment.

The standards shown in FIG. 12 are applicable only when one boundary Lref is set on the display surface 11.

Standard 11 and standard 12 are standards used for image switching when the shifting direction is the upward direction. Standard 13 and standard 14 are standards used for image switching when the shifting direction is the downward direction.

The difference between standard 11 and standard 12 is whether or not a specific portion (character string in FIGS. 11A and 11B) has crossed over the boundary Lref in the upward direction.

While the specific portion disappeared from the top end and appeared again from the bottom end in response to the upward shifting has not crossed over the boundary Lref in the upward direction (when the relationship of the specific portion to the boundary Lref satisfies standard 11), image switching is not performed. That is, a currently displayed image is circulated (rotated) upward while being continuously displayed.

If the specific portion has crossed over the boundary Lref in the upward direction (when the relationship of the specific portion to the boundary Lref satisfies standard 12), image switching is performed. In the second exemplary embodiment, the currently displayed image is switched to the next image.

Standard 13 and standard 14 will be discussed later.

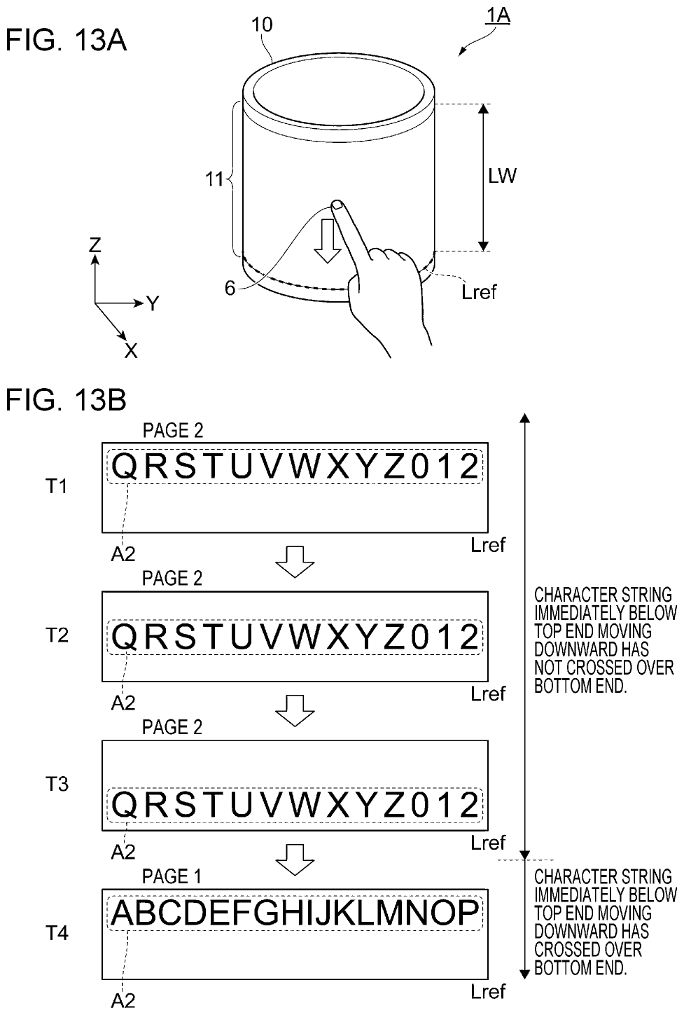

FIGS. 13A and 13B illustrate another example of the shifting of the display position of an image according to the second exemplary embodiment. FIG. 13A shows a user operation performed on the information processing apparatus 1A. FIG. 13B shows the transition of displayed images in response to a shifting operation.

In FIGS. 13A and 13B, elements corresponding to those in FIGS. 11A and 11B are designated by like reference numerals.

In FIGS. 13A and 13B, the image is shifted from the top end to the bottom end.

At time T1, page 2 is displayed as the unit of display. At time T1, a user has not yet provided a shifting instruction.

In this case, the character string “QRSTUVWXYZ012” is displayed immediately below the top end. That is, the character string is arranged at the top section of the display surface 11.

For the sake of representation, the head of the character string is “Q”. In the example in FIGS. 13A and 13B, the character string “QRSTUVWXYZ012” positioned at the top section is used as the specific portion A2 for the downward shifting.

At time T2, the user has moved the fingertip 6 in the downward direction, and the arrangement of the character string displayed on the display surface 11 is indicated. At time T2, the character string “QRSTUVWXYZ012” is moved to the middle section of the display surface 11.

At time T3, the user has moved the fingertip 6 further in the downward direction, and the arrangement of the character string displayed on the display surface 11 is indicated. At time T3, the character string “QRSTUVWXYZ012” is moved to the bottom section of the display surface 11.

At time T4, as a result of the user moving the fingertip 6 further in the downward direction, the image displayed on the display surface 11 has changed from page 2 to page 1.

Referring back to a description with reference to FIG. 12, the standards used in this display example are standard 13 and standard 14.

The difference between standard 13 and standard 14 is whether or not a specific portion (character string in FIGS. 13A and 13B) has crossed over the boundary Lref in the downward direction.

While the entirety of the specific portion has not crossed over the boundary Lref in the downward direction (when the relationship of the specific portion to the boundary Lref satisfies standard 13), image switching is not performed. That is, a currently displayed image is circulated (rotated) downward while being continuously displayed.

If the entirety of the specific portion has crossed over the boundary Lref in the downward direction (when the relationship of the specific portion to the boundary Lref satisfies standard 14), image switching is performed. In the second exemplary embodiment, the currently displayed image is switched to the previous image.

### Third Exemplary Embodiment

In a third exemplary embodiment, setting of plural boundaries Lref within the display surface 11 will be discussed below.

In the first and second exemplary embodiments, the entirety of an image displayed on the display surface 11 is switched to another image on condition that a specific portion of the displayed image has crossed over the boundary Lref in a certain direction selected by a user. Under this condition, however, the distance by which a user is required to move a displayed image until the boundary Lref may become long depending on the size of the display surface 11.

In the third exemplary embodiment, a pair of boundaries Lref is set according to the shifting direction, and an image displayed on the display surface 11 will be switched to another image on condition that a specific portion of the image located with respect to one boundary Lref1 has crossed over the other boundary Lref2 in the shifting direction.

In the third exemplary embodiment, the distance between a pair of boundaries Lref is the distance by which a user is required to move a displayed image to switch it to another image. This enables the user to perform image switching more quickly.

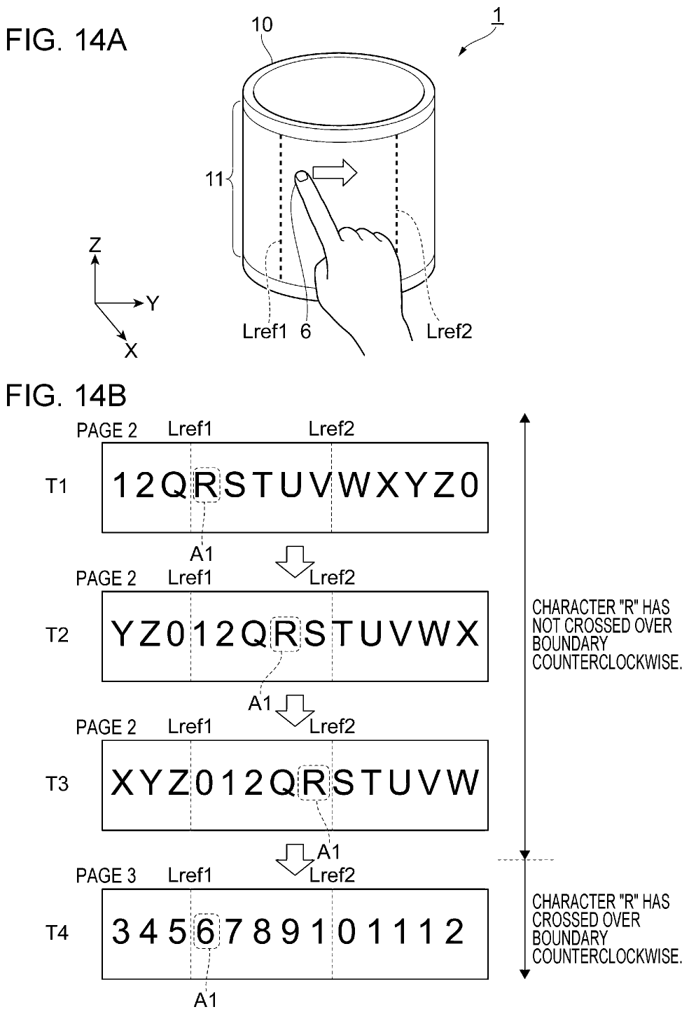

FIGS. 14A and 14B illustrate an example of the shifting of the display position of an image according to the third exemplary embodiment. FIG. 14A shows a user operation performed on the information processing apparatus 1. FIG. 14B shows the transition of displayed images in response to a shifting operation.

The hardware configuration and the functional configuration of the information processing apparatus 1 of the third exemplary embodiment are similar to those of the first exemplary embodiment (see FIGS. 2 and 3).

In FIGS. 14A and 14B, elements corresponding to those in FIGS. 8A and 8B are designated by like reference numerals.

The display surface 11 shown in FIGS. 14A and 14B is different from that in FIGS. 8A and 8B in that two boundaries Lref1 and Lref2 are set on the circumference of the display surface 11.

There are two sections sandwiched between the boundaries Lref1 and Lref2 in the circumferential direction. The third exemplary embodiment focuses a smaller section. It is however not necessary to distinguish the two sections from each other when determining whether image switching will be performed because the positional relationship in the smaller section satisfies a certain switching standard earlier than that in the larger section.

At time T1, page 2 is displayed as the unit of display. At time T1, a user has not yet provided a shifting instruction.

In FIG. 14B, the character string “12QRSTUVWXYZ0” is displayed in the middle section of the display surface 11. For the sake of representation, “1” is disposed at the head of the character string.

In the third exemplary embodiment, the character “R” displayed next to the left-side boundary Lref1 (may also be called boundary 1) on the right side (counterclockwise) is selected as a specific portion A1.

At time T2, the user has moved the fingertip 6 in the rightward direction (counterclockwise), and the arrangement of the character string displayed on the display surface 11 is indicated. At time T2, the position of the image is shifted in the rightward direction by three characters with respect to that at time T1.

At time T3, the user has moved the fingertip 6 further in the rightward direction (counterclockwise), and the arrangement of the character string displayed on the display surface 11 is indicated. At time T3, the position of the image is shifted in the rightward direction by one character with respect to that at time T2.

In this state, if the user moves the fingertip 6 in the rightward direction (counterclockwise), the character “R”, which is the specific portion A1, will cross over the boundary Lref2 (may also be called boundary 2) in the rightward direction (counterclockwise).

At time T4, the arrangement of the character string after the image displayed on the display surface 11 has changed from page 2 to page 3 is indicated.

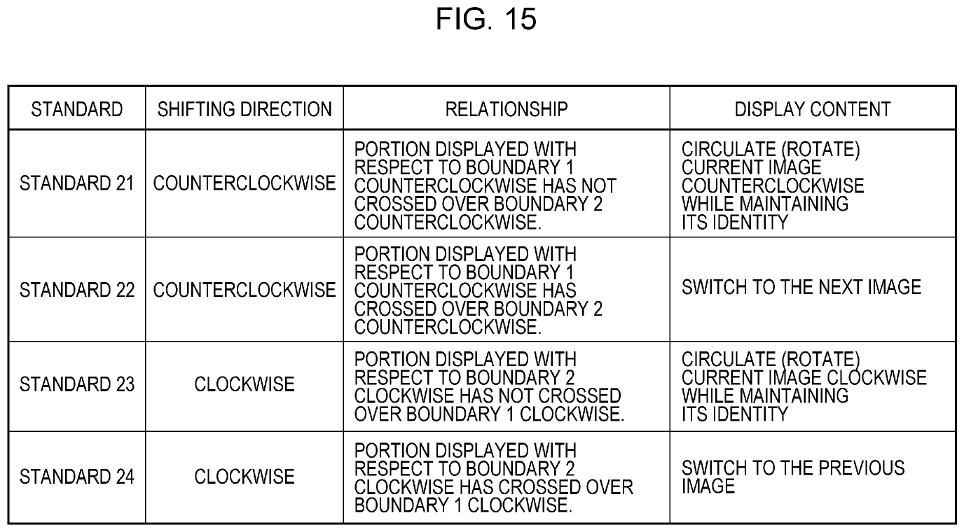

FIG. 15 is a table illustrating examples of the standards set by the switching standard setter 31 (see FIG. 3) and used in the third exemplary embodiment.

Standard 21 and standard 22 are standards used for image switching when the shifting direction is the rightward direction (counterclockwise). Standard 23 and standard 24 are standards used for image switching when the shifting direction is the leftward direction (clockwise).

The difference between standard 21 and standard 22 is whether or not the specific portion A1 (character “R” in FIG. 14B, for example) displayed next to boundary 1 on the right side (counterclockwise) has crossed over boundary 2 in the counterclockwise direction.

While the specific portion A1 has not crossed over boundary 2 (when the relationship of the specific portion to boundary 2 satisfies standard 21), image switching is not performed. That is, a currently displayed image is circulated (rotated) counterclockwise while being continuously displayed.

If the specific portion A1 has crossed over boundary 2 (when the relationship of the specific portion to boundary 2 satisfies standard 22), image switching is performed. In the third exemplary embodiment, the currently displayed image is switched to the next image.

Standard 23 and standard 24 will be discussed later.

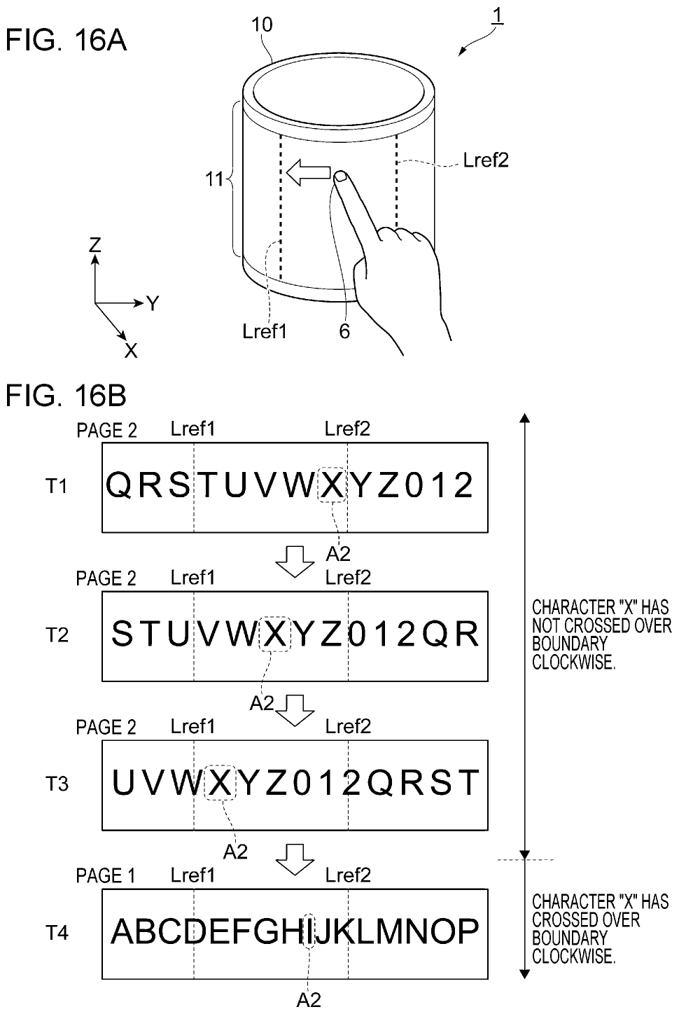

FIGS. 16A and 16B illustrate another example of the shifting of the display position of an image according to the third exemplary embodiment. FIG. 16A shows a user operation performed on the information processing apparatus 1. FIG. 16B shows the transition of displayed images in response to a shifting operation.

In FIGS. 16A and 16B, elements corresponding to those in FIGS. 14A and 14B are designated by like reference numerals.

In this example, an image is shifted in the leftward direction (clockwise).

At time T1, page 2 is displayed as the unit of display. At time T1, a user has not yet provided a shifting instruction.

In FIGS. 16A and 16B, the character string “QRSTUVWXYZ012” is displayed at the middle section of the display surface 11. For the sake of representation, “Q” is disposed at the head of the character string.

In the third exemplary embodiment, the character “X” displayed next to the right-side boundary Lref2 (boundary 2) on the left side (clockwise) is selected as a specific portion A2.

At time T2, the user has moved the fingertip 6 in the leftward direction (clockwise), and the arrangement of the character string displayed on the display surface 11 is indicated. At time T2, the position of the image is shifted in the leftward direction by two characters with respect to that at time T1.

At time T3, the user has moved the fingertip 6 further in the leftward direction (clockwise), and the arrangement of the character string displayed on the display surface 11 is indicated. At time T3, the position of the image is shifted in the leftward direction by two characters with respect to that at time T2.

In this state, if the user moves the fingertip 6 in the leftward direction (clockwise), the character “X”, which is the specific portion A2, will cross over the left-side boundary Lref1 (boundary 1) in the leftward direction (clockwise).

At time T4, the arrangement of the character string after the image displayed on the display surface 11 has changed from page 2 to page 1 is indicated.

Referring back to a description with reference to FIG. 15, the standards used in this type of display are standard 23 and standard 24.

The difference between standard 23 and standard 24 is whether or not the specific portion A2 (character “X” in FIG. 16B, for example) displayed next to boundary 2 on the left side (clockwise) has crossed over boundary 1 in the clockwise direction.

While the specific portion A2 has not crossed over boundary 1 (when the relationship of the specific portion to boundary 1 satisfies standard 23), image switching is not performed. That is, a currently displayed image is circulated (rotated) clockwise while being continuously displayed.

If the specific portion A2 has crossed over boundary 1 (when the relationship of the specific portion to boundary 1 satisfies standard 24), image switching is performed. In the third exemplary embodiment, the currently displayed image is switched to the previous image.

### Fourth Exemplary Embodiment

In a fourth exemplary embodiment, only part of an image on the display surface 11 is cyclically shifted or rotated in a direction selected by a user while maintaining the identity of the image of this part, and the other part of the display surface 11 is not influenced by the shifting of this part.

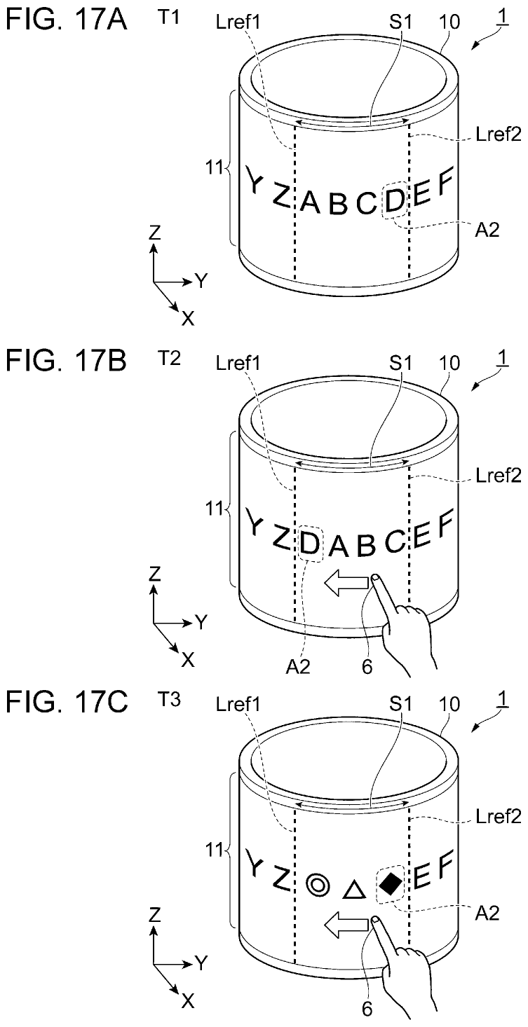

FIGS. 17A through 17C illustrate an example of the shifting of the display position of an image according to the fourth exemplary embodiment. FIGS. 17A through 17C show the transition of displayed images in response to a shifting operation.

In FIGS. 17A through 17C, elements corresponding to those in FIGS. 16A and 16B are designated by like reference numerals.

As in the third exemplary embodiment, a pair of boundaries Lref1 and Lref2 is set in the circumferential direction.

In the fourth exemplary embodiment, an image displayed in a smaller one of the sections sandwiched between the boundaries Lref1 and Lref2 is used as the unit of display. That is, part of the display surface 11 is selected as a region S1 where an image is cyclically circulated or rotated while maintaining its identity.

At time T1, an alphabetical character string “ABCD . . . YZ” is displayed along the display surface 11 in the circumferential direction.

The first boundary Lref1 is set between the characters “A” and “Z”, while the second boundary Lref2 is set between the characters “D” and “E”.

At time T2, a user provides an instruction with a fingertip 6 to shift the image displayed in the region S1 sandwiched between the pair of boundaries Lref1 and Lref2 in the leftward direction (clockwise).

In this case, the character “D” next to the boundary Lref2 (boundary 2) in the leftward direction (clockwise) is the specific portion A2.

In the fourth exemplary embodiment, at time T2, only the four characters A, B, C, and D are cyclically shifted in the region S1 in the leftward direction (clockwise), and the display positions of the other characters outside the region S1 (characters Y, Z, E, and F, for example) remain the same.

At time T2, the specific portion A2 has moved to the position next to the first boundary Lref1 (boundary 1) on the right side.

In this state, when the user moves the fingertip 6 further in the leftward direction (clockwise), part of the character “D”, which is the specific portion A2, disappears from the screen beyond the left-side boundary Lref1 (boundary 1) of the region S1 and appears again from the right-side boundary Lref2 (boundary 2).

At time T3, the entirety of the specific portion A2 has crossed over the boundary Lref1 (boundary 1), and the entire image displayed in the region S is switched to an image constituted by symbols.

At time T3, only in the region S1, the image constituted by A, B, C, and D is switched to an image constituted by a double circle, a triangle, and a filled rhombus.

Displaying of the image in the region other than the region S1 has not been discussed with reference to FIGS. 17A through 17C. The image in this region sandwiched between the boundary Lref1 (boundary 1) and the boundary Lref2 (boundary 2) may be scrolled through. Alternatively, as in the region S1, the image in this region may also be cyclically shifted while maintaining its identity, and may be switched to another image on condition that the relationship of a specific portion in this region to one of the boundaries Lref1 and Lref2 satisfies a certain standard.

### Fifth Exemplary Embodiment

In a fifth exemplary embodiment, a boundary Lref is set for each of plural regions of the display surface 11.

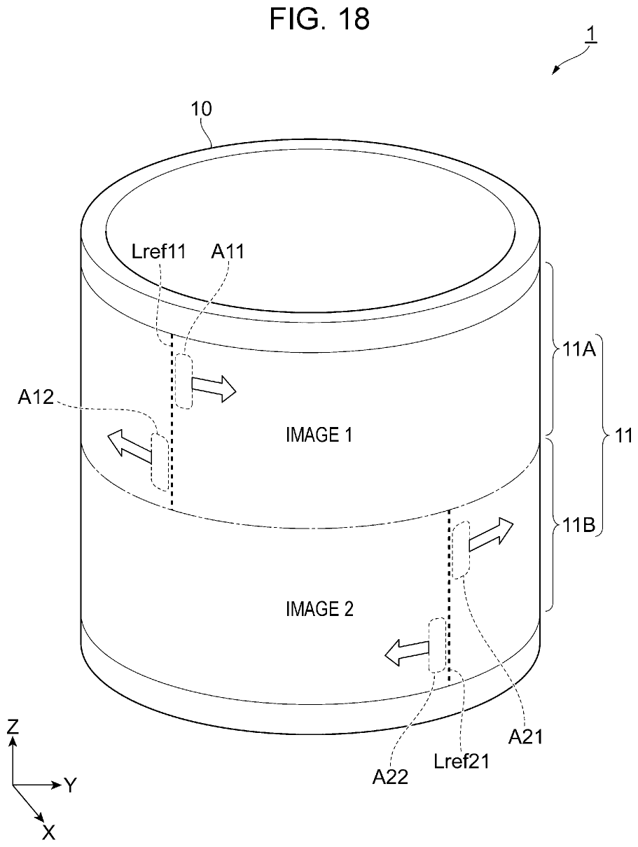

FIG. 18 illustrates an example of the setting of boundaries Lref according to the fifth exemplary embodiment.

The hardware configuration and the functional configuration of an information processing apparatus 1 shown in FIG. 18 are similar to those of the information processing apparatus 1 of the first exemplary embodiment (see FIGS. 2 and 3).

In the information processing apparatus 1 in FIG. 18, a cylindrical display surface 11 is divided into an upper partial display surface 11A and a lower partial display surface 11B. That is, in FIG. 18, two images are used as the unit of display on the display surface 11, and the boundary Lref is set for each of the images, which serve as the unit of display.

The reason why different boundaries Lref are set is that, since image 1 displayed on the upper partial display surface 11A and image 2 displayed on the lower partial display surface 11B are different images, the position at which a user wishes to switch the image may also be different between image 1 and image 2.

FIG. 18 shows that the position of a boundary Lref11 set on the upper partial display surface 11A and the position of a boundary Lref21 set on the lower partial display surface 11B are different in the circumferential direction.

Image 1 displayed on the upper partial display surface 11A and image 2 on the lower partial display surface 11B are cyclically shifted or rotated independently of each other in a direction selected by a user while maintaining the identities of image 1 and image 2. The entirety of image 1 is switched to a different image as a result of a specific portion A11 or A12 crossing over the boundary Lref11 in the corresponding direction. The entirety of image 2 is switched to a different image as a result of a specific portion A21 or A22 crossing over the boundary Lref21 in the corresponding direction.

In the example in FIG. 18, the display surface 11 is divided into two partial display surfaces, that is, the upper partial display surface 11A and the lower partial display surface 11B. However, the display surface 11 may be divided into three or more partial display surfaces.

A user may set a position at which the display surface 11 is divided. Alternatively, the information processing apparatus 1 may set a dividing position based on the layout of an image displayed on the display surface 11.

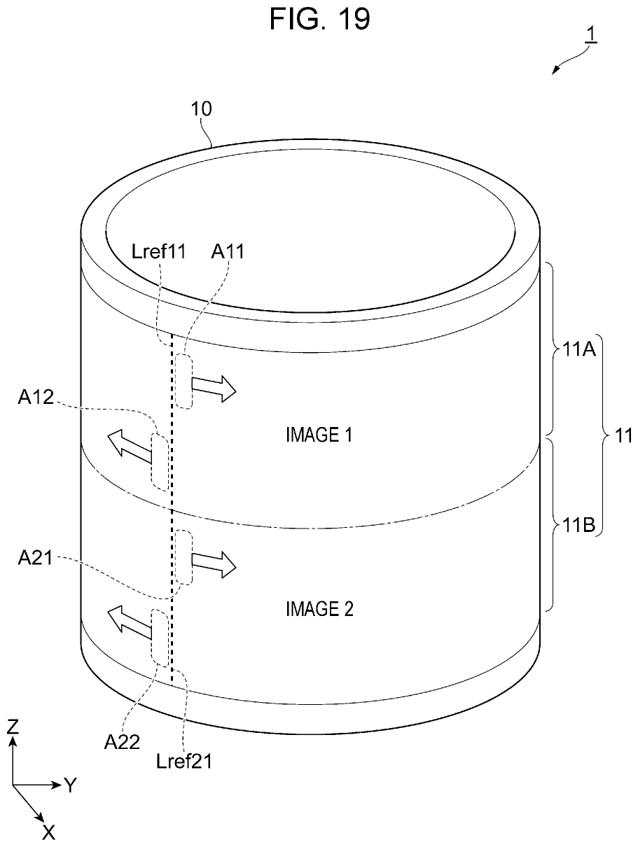

FIG. 19 illustrates another example of the setting of boundaries Lref according to the fifth exemplary embodiment. In FIG. 19, elements corresponding to those in FIG. 18 are designated by like reference numerals.

In the example in FIG. 19, the circumferential position of the boundary Lref11 set on the upper partial display surface 11A and that of the boundary Lref21 set on the lower partial display surface 11B are the same.

Although the circumferential position at which image switching is performed on the upper partial display surface 11A and that on the lower partial display surface 11B are the same, image 1 and image 2 are shifted independently of each other in response to a user instruction.

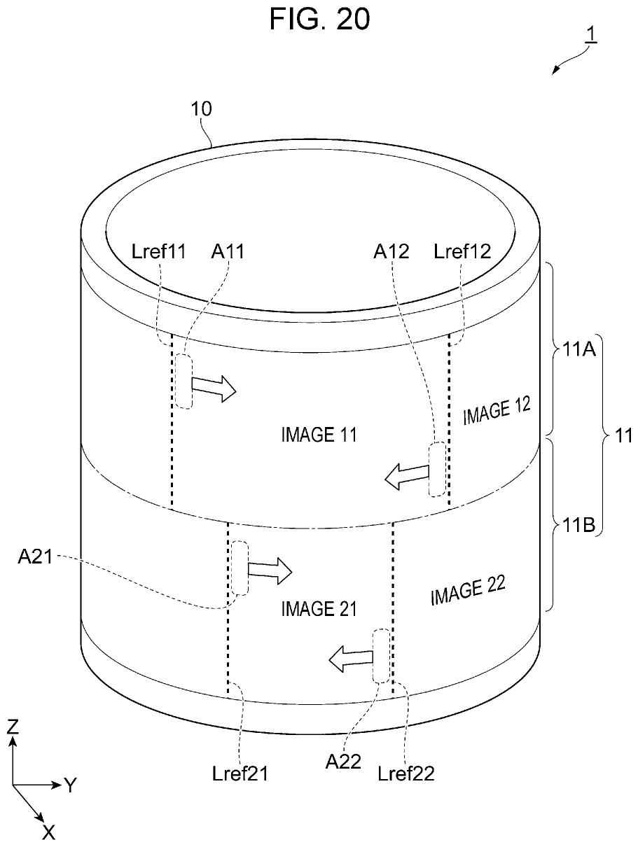

FIG. 20 illustrates another example of the setting of boundaries Lref according to the fifth exemplary embodiment. In FIG. 20, elements corresponding to those in FIGS. 18 and 19 are designated by like reference numerals.

In the example in FIG. 20, as in the third exemplary embodiment (see FIGS. 14A, 14B, 16A, and 16B), the distance by which a user is required to move an image on the upper partial display surface 11A to switch it to another image and that on the lower partial display surface 11B are different.

Two boundaries Lref11 and Lref12 are set on the circumference of the upper partial display surface 11A, while two boundaries Lref21 and Lref22 are set on the circumference of the lower partial display surface 11B.

As in the fourth exemplary embodiment (see FIGS. 17A through 17C), plural regions may be set on each of the upper and lower partial display surfaces 11A and 11B of the display surface 11. In each region, an image is cyclically shifted or rotated in a direction selected by a user while maintaining the identity of the image.

### Sixth Exemplary Embodiment

In the first through fifth exemplary embodiments, the body 10 of the information processing apparatus 1 (see FIGS. 1A and 1B) has a cylindrical shape and the display surfaces 11 are continuously disposed by 360° along the circumferential surface. However, the body 10 is not limited to a cylindrical shape.

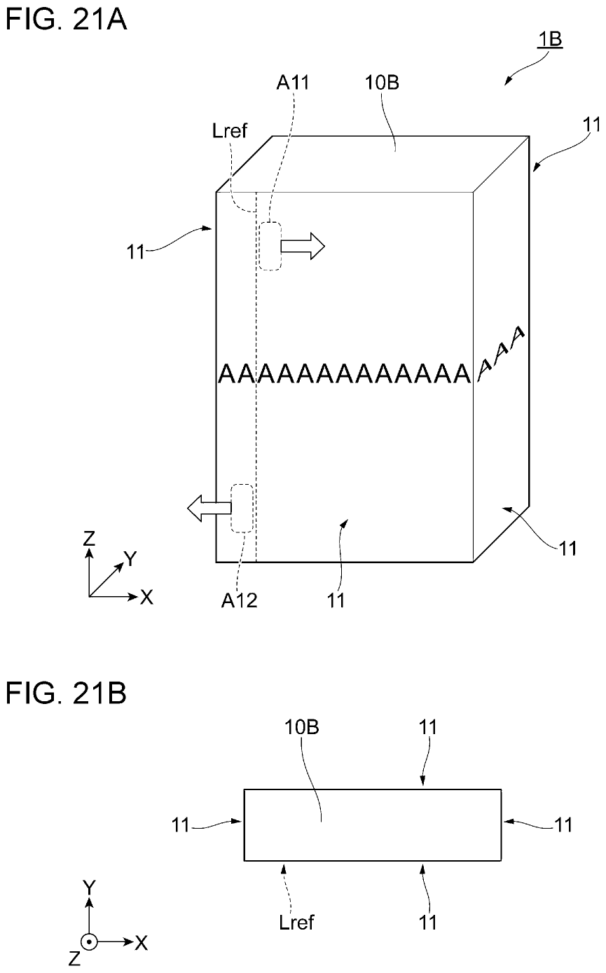

FIGS. 21A and 21B illustrate an information processing apparatus 1B including a body 10B formed in a cuboid shape and four display surfaces 11 disposed continuously on the peripheral surface of the body 10B according to a sixth exemplary embodiment. FIG. 21A illustrates the outer appearance of the information processing apparatus 1B as viewed from above obliquely. FIG. 21B illustrates the outer appearance of the information processing apparatus 1B as viewed from above.

Examples of this type of information processing apparatus 1B are a tablet terminal, a smartphone, and a monitor. The housing (that is, the display surfaces 11) of the information processing apparatus 1B may be deformable into one or multiple shapes. In other words, the information processing apparatus 1B may be a flexible display.

For example, if the information processing apparatus 1B is a band-like flexible display, it may be rounded into a cylindrical shape for use.

The display surfaces 11 in the sixth exemplary embodiment are different from the display surface 11 in the first exemplary embodiment in that the four planar display surfaces 11 are continuously disposed. However, the display surfaces 11 in the sixth exemplary embodiment may be used similarly to the display surface 11 in the first exemplary embodiment. For example, an image displayed on the display surface 11 shown in FIGS. 1A and 1B may be distributed among the display surfaces 11 shown in FIGS. 21A and 21B.

A user may alternatively use the four display surfaces 11 independently as different display devices. In this case, the image displayed on one display surface 11 is not changed in response to a change in the image on another display surface 11. Or, the image displayed only on a particular display surface 11 may not be changed in response to a change in the image on another display surface 11.

In the example in FIG. 21A, the boundary Lref is set at the left portion of the display surface 11 on the front side in the plane of the drawing.

### Seventh Exemplary Embodiment

In the first through sixth exemplary embodiments, an image can be displayed continuously by 360° in one direction. In a seventh exemplary embodiment, an image can be displayed continuously by 360° in any direction selected by a user.

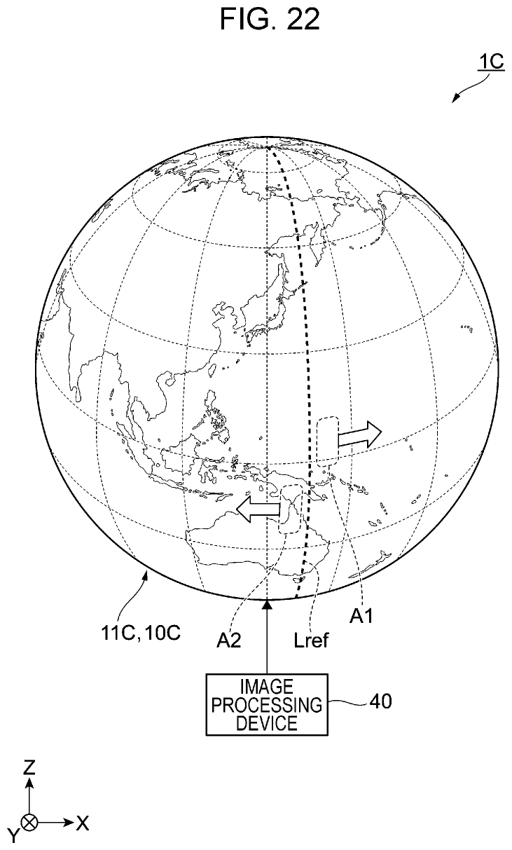

FIG. 22 illustrates an information processing apparatus 1C including a body 10C formed in a spherical shape and a display surface 11C disposed on the surface of the body 10C according to a seventh exemplary embodiment.

The display surface 11C is formed in a spherical shape so that the user can move an image displayed on the display surface 11C in any desired direction.

In the example in FIG. 22, a certain longitude is used as a boundary Lref. A latitude may alternatively be used as a boundary Lref. A boundary Lref may alternatively be set regardless of the orientations of latitudes and longitudes.

The spherical display surface 11C is molded from a material, such as glass or plastic resin, so as to have high transparency. The information processing apparatus 1C also includes an image processing device 40.

The image processing device 40 includes a CPU, a ROM, a RAM, and a communication module. The CPU controls the entirety of the information processing apparatus 1C as a result of executing a program (including basic software). The ROM stores programs, such as BIOS and basic software. The RAM is used as a work area for programs. The communication module is used for communicating with an external device.

The image processing device 40 displays an image on the display surface 11C by using a communication module. The image processing device 40 may alternatively be provided within the display surface 11C.

Various techniques may be used to display an image on the spherical display surface 11C, such as projecting an image from the inside of the spherical surface, projecting an image from the outside of the spherical surface, turning ON LEDs disposed on the entirety of the spherical surface to display an image, and rotating a ring-like member having an array of LEDs at high speed within the spherical body and allowing a user to have an afterimage of LED light.

A function of detecting the position of the fingertip 6 of a user on the display surface 11C is also provided on the display surface 11C. Alternatively, the movement of the fingertip 6 may be detected from an image of the display surface 11C captured by a camera.

The information processing apparatus 1C including the display surface 11C and the image processing device 40 separated from each other, as shown in FIG. 20, is an example of an information processing system.

As in the fifth exemplary embodiment (see FIGS. 18 through 20), a boundary Lref may be set on each of plural regions of the spherical display surface 11C.

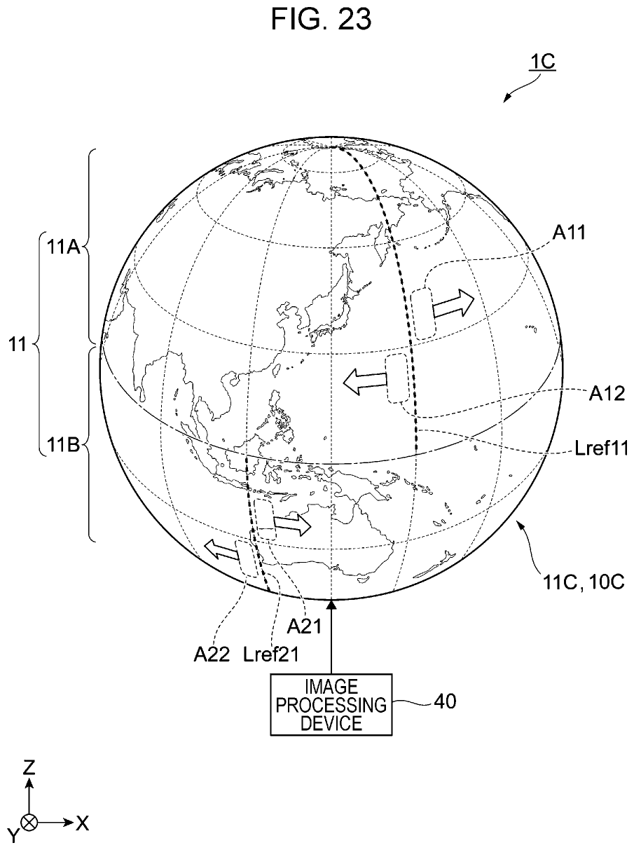

FIG. 23 illustrates an example in which the spherical display surface 11C is divided into an upper-hemisphere partial display surface 11A and a lower-hemisphere partial display surface 11B.

In the example in FIG. 23, the circumferential position at which the boundary Lref11 is set on the upper-hemisphere partial display surface 11A and that at which the boundary Lref21 is set on the lower-hemisphere partial display surface 11B are different.

### Eighth Exemplary Embodiment

In the first through seventh exemplary embodiments, while an image is shifting in response to a user instruction, when a specific portion of the image has crossed over a boundary Lref in a predetermined direction, the image is immediately switched to another image.

In the first through seventh exemplary embodiments, a user can only predict that an image displayed on the display surface 11 will soon be switched based on the display positions of the elements forming the image.

In an eighth exemplary embodiment, a user is informed that image switching will soon occur.

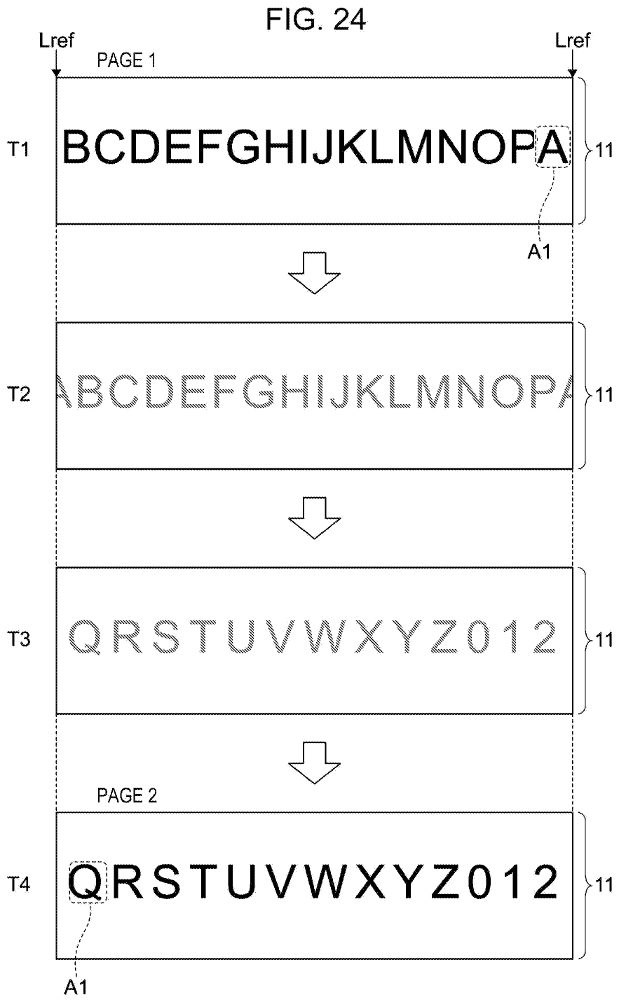

FIG. 24 illustrates an example of a technique for informing a user that image switching will soon occur according to the eighth exemplary embodiment. In this example, in accordance with image switching, a currently displayed image gradually fades out (becomes paler) and another image gradually fades in (becomes thicker).

In the example in FIG. 24, the user moves a fingertip 6 in the rightward direction (counterclockwise) to rotate the position of the displayed image within the display surface 11. In the example in FIG. 24, page 1 is switched to page 2.

At time T1, page 1 will soon be switched to page 2. The character string “BCDEFGHIJKLMNOPA” is displayed in this order in the rightward direction from the left-side reference position (boundary Lref). Shifting of this image in the rightward direction (counterclockwise) by one more character will switch page 1 to page 2.

At time T2, page 1 is shifted farther to the right side than that at time T1, and the image has started to fade out with a reduced density (or brightness).

As a result of shifting page 1 farther to the right side, at time T3, page 1 has disappeared and page 2 has started to fade in. Between time T2 and time T3, an image indicating a mixture of page 1 and page 2 may be displayed. At time T4, page 2 is displayed with an increased density (or brightness).

Changing of the density (or the brightness) of the image from time T1 to time T3 makes it possible to let the user know that image switching will soon occur.

### Ninth Exemplary Embodiment

In the first through eighth exemplary embodiments, the display surfaces are all physically tangible objects. In a ninth exemplary embodiment, a display surface is formed optically in the air.

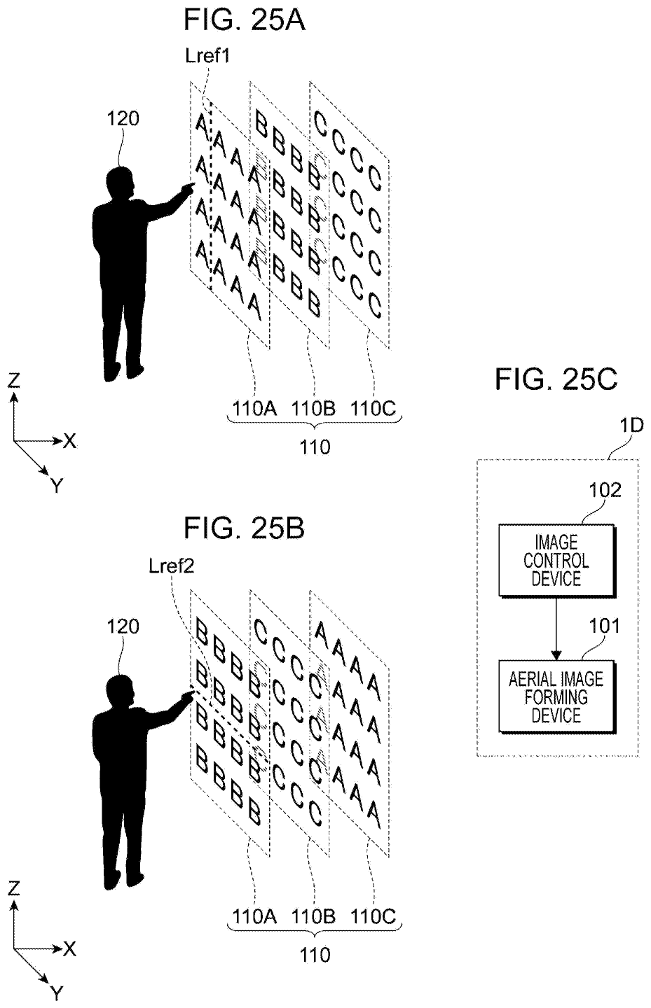

FIGS. 25A through 25C illustrate the schematic configuration of an information processing apparatus 1D which forms an aerial image 110 in the air according to the ninth exemplary embodiment. The information processing apparatus 1D is an example of the information processing system. FIG. 25A illustrates a user 120 providing an instruction to shift the display position of the aerial image 110 by using an aerial image 110A positioned closest to the user 120. FIG. 25B illustrates the aerial image 110 after the display position of the aerial image 110 has been switched.

In the ninth exemplary embodiment, the aerial image 110 is an image formed in the air so as to reproduce the state of light equivalent to light reflected by an object. The aerial image 110 is formed as if it were floating in the air, so that the user 120 can pass through the aerial image 110.

For example, an information screen or an advertising screen may be displayed in the aerial image 110. An operating screen may be displayed in the aerial image 110. On the operating screen, the display content is changed in accordance with an operation of the user 120. These screens are only examples to be displayed in the aerial image 110.

Not only still images, video images may be displayed in the aerial image 110.

In the ninth exemplary embodiment, the entirety of a rectangular shape is used as the aerial image 110. However, the shape which defines the outer edges of the aerial image 110 is not limited to a rectangle. For example, a space in which the image of an object is formed may be used as the space in which the aerial image 110 is formed. Images of an operation button, a person, an animal, a product, and a fruit are examples of the aerial image 110. Although the aerial image 110 has a planar shape in FIGS. 25A and 25B, it may have a three-dimensional shape, such as a curved surface, a sphere, or a cube.

The aerial image 110 may be constituted by a single image. The aerial image 110 may alternatively be constituted by multiple images in one space. In FIGS. 25A and 25B, three planar aerial images 110A, 110B, and 110C are arranged in the depth direction in this order as viewed from the user 120.

In FIGS. 25A and 25B, the aerial image 110A is constituted by “AAAA/AAAA/AAAA/AAAA”. The aerial image 110B is constituted by “BBBB/BBBB/BBBB/BBBB”, and the aerial image 110C is constituted by “CCCC/CCCC/CCCC/CCCC”. In all the aerial images 110A, 110B, and 110C, a slash indicates that a new line starts here.

In FIGS. 25A and 25B, the aerial images 110A, 110B, and 110C are disposed such that adjacent aerial images oppose each other with a predetermined distance therebetween. In this case, the first page is displayed in the aerial image 110A, the second page is displayed in the aerial image 110B, and the third page is displayed in the aerial image 110C.

FIGS. 25A and 25B show an example in which the image on the current page is switched to the image on the next page in response to a user instruction. The first page displayed in the aerial image 110A at the front row in FIG. 25A is shifted to the back row in FIG. 25B, and the second page is displayed in the aerial image 110A at the front row in FIG. 25B. That is, the images displayed in the aerial images 110A, 110B, and 110C are moved forward from the back side page by page. Shifting of the first page to the back row is an example of backward shifting.

If image switching in response to a user instruction is conducted in the opposite direction, the image of the third page displayed in the aerial image 110C at the back row is shifted to the aerial image 110A at the front row.

In this case, the first page displayed in the aerial image 110A is shifted to the aerial image 110B at the intermediate row, and the second page displayed in the aerial image 110B is shifted to the aerial image 110C at the back row. That is, the images displayed in the aerial images 110A, 110B, and 110C are moved backward page by page. Shifting of the first page to the intermediate row is also an example of backward shifting.

In this example, multiple pages forming a document are arranged in the multiple aerial images 110A through 110C in the depth direction as viewed from the user 120. However, instead of pages forming a document, drawings or a hierarchical structure, for example, may be arranged in the multiple aerial images 110A through 110C.

The position of the boundary Lref set on the first page “AAAA/AAAA/AAAA/AAAA” and the shifting direction of the image shown in FIG. 25A and that of the boundary Lref set on the second page “BBBB/BBBB/BBBB/BBBB” and the shifting direction of the image shown in FIG. 25B are different from each other.

More specifically, in FIG. 25A, the boundary Lref1 on the first page is vertically set, while the boundary Lref2 on the second page is horizontally set. When the image on the first page has circulated horizontally through one revolution, the current page is switched to the next page (second page) or the previous page (third page). When the image on the second page has circulated vertically through one revolution, the current page is switched to the next page (third page) or the previous page (first page).

The information processing apparatus 1D shown in FIG. 25C includes an aerial image forming device 101, an image control device 102, an imaging camera (not shown), and a microphone (not shown). The aerial image forming device 101 forms the aerial image 110 in the air. The image control device 102 performs control so that the aerial image forming device 101 forms the aerial image 110. The imaging camera captures an image of the user 120 providing an instruction for the aerial image 110. The microphone converts voice of the user 120 into an electric signal.

In FIG. 25C, the single aerial image forming device 101 forms the aerial images 110A, 110B, and 110C. However, different aerial image forming devices may be provided for individually forming the aerial images 110A, 110B, and 110C.

The aerial image forming device 101 is an example of an image forming unit.

The image control device 102 recognizes the content of an instruction provided by the user 120 so as to cause the aerial image forming device 101 to form the aerial images 110A, 110B, and 110C. To recognize the content of the instruction, the image control device 102 uses an image recognition technique of recognizing an image input from the imaging camera and a voice recognition technique of recognizing voice input from the microphone.

The image control device 102 analyzes the motion of a hand or a finger of the user 120, for example, to identify which aerial image the user 120 has selected and the content of an instruction provided by the user 120 for the selected aerial image.

The image control device 102 may alternatively identify the content of the instruction by receiving a signal from a terminal, such as a remote controller.

The image control device 102 is an example of a controller and is also an example of the information processing apparatus.

The imaging camera is disposed at a position at which it can capture an image of the motion of a hand or a fingertip of a user. The imaging camera may also capture an image of the face of a user so that it can identify the content of an instruction from the facial expression or the gaze of this user.

As the imaging camera, a single imaging camera or plural imaging cameras may be provided. Plural imaging cameras may be installed at different positions and may capture images from different angles. This reduces blind spots, thereby increasing the precision in detecting the movement of the user 120 and identifying the content of an instruction provided by the user 120. Instead of an imaging camera, various sensors may be used. For example, a sensor for detecting the position of a hand or a finger of a user blocking infrared light and for detecting the direction of movement of a hand or a finger of a user may be used. The imaging cameras and sensors are examples of a detector.

The microphone (not shown) is used for inputting voice of the user 120 providing an instruction. The microphone is also an example of the detector.

An explanation will be given through illustration of examples of how the aerial image forming device 101 forms the aerial image 110.

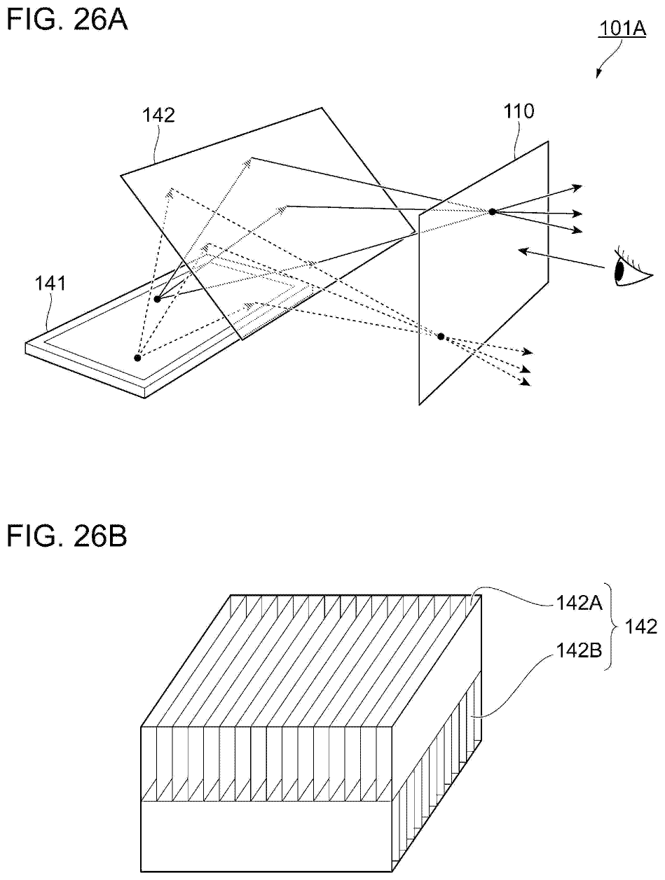

FIGS. 26A and 26B are views for explaining how an aerial image forming device 101A forms an aerial image 110. The aerial image forming device 101A forms the aerial image 110 by causing a dedicated optical plate 142 to transmit light output from a display device 141. FIG. 26A illustrates the positional relationship of the aerial image 110 to the display device 141 and the optical plate 142. FIG. 26B illustrates part of the sectional structure of the optical plate 142. The display device 141 and the optical plate 142 are examples of optical parts.

The optical plate 142 is constituted by two plates vertically overlaid on each other. More specifically, in one plate, glass strips 142A using a wall surface as a mirror are arranged, and in the other plate, glass strips 142B are arranged perpendicularly to the arrangement of the glass strips 142A.

The optical plate 142 reflects light output from the display device 141 twice by using the glass strips 142A and 142B to form an image in the air, thereby reproducing the image displayed on the display device 141 in the air. The distance between the display device 141 and the optical plate 142 is equal to that between the optical plate 142 and the aerial image 110. The dimensions of the image displayed on the display device 141 and those of the aerial image 110 are the same.

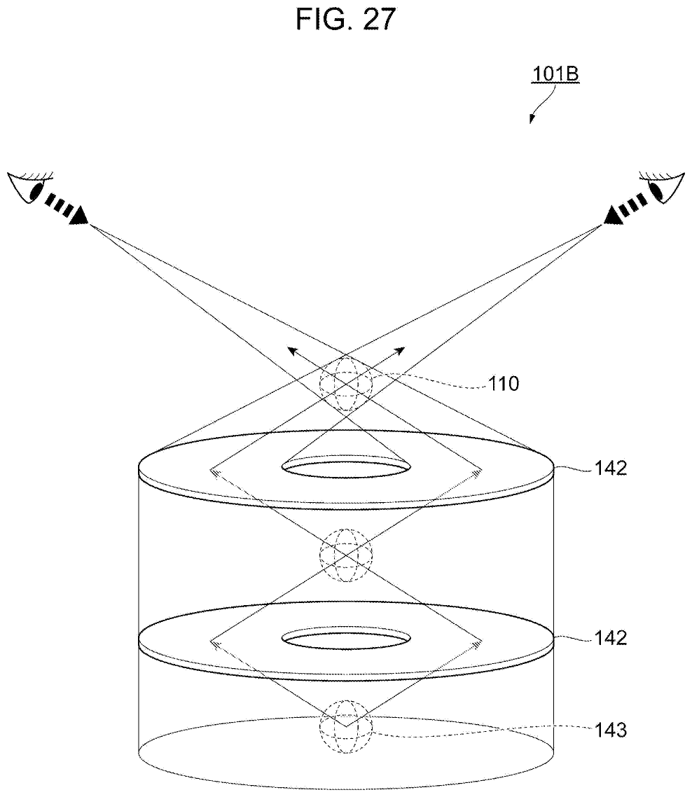

FIG. 27 is a view for explaining how an aerial image forming device 101B forms a three-dimensional image as an aerial image 110. The aerial image forming device 101B causes ring-like optical plates 142 to transmit light twice reflected on the surface of an actual object 143, thereby reproducing a three-dimensional image (aerial image 110) in the air. It is not necessary that the optical plates 142 be disposed in series with each other.

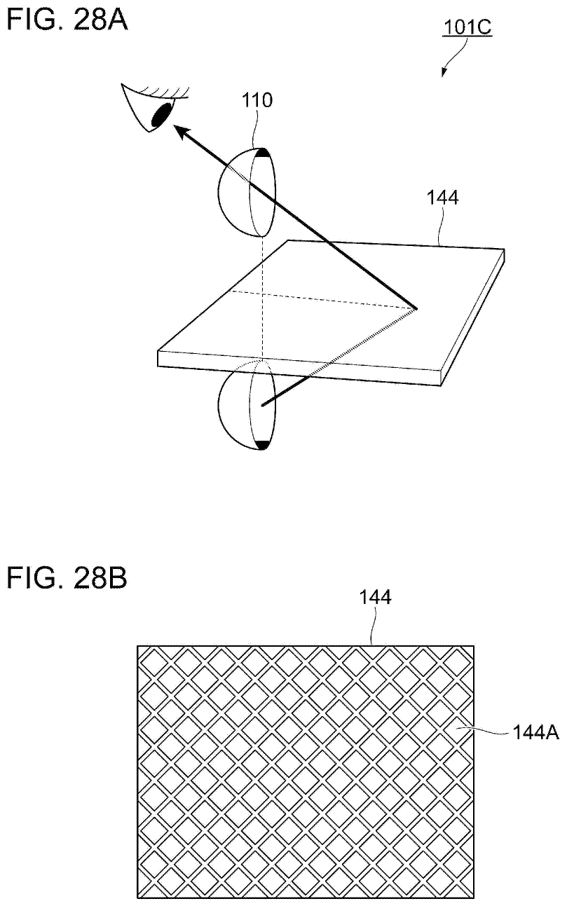

FIGS. 28A and 28B are views for explaining how an aerial image forming device 101C forms an aerial image 110 by using a micromirror array 144. In the micromirror array 144, minute square holes which form a dihedral corner reflector are arranged at equal intervals in the plane. FIG. 28A illustrates the positional relationship of the aerial image 110 to the micromirror array 144. FIG. 28B is a partially enlarged view of the micromirror array 144. One hole 144A has a 100-μm×100-μm square, for example. The micromirror array 144 is an example of optical parts.

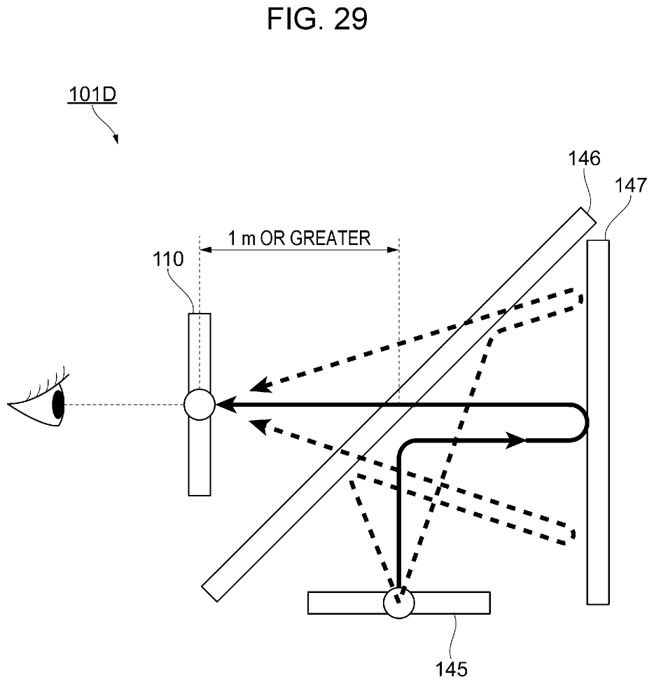

FIG. 29 is a view for explaining how an aerial image forming device 101D forms an aerial image 110 by using a beam splitter 146 and a retroreflective sheet 147. The beam splitter 146 is disposed at 45° with respect to the display surface of a display device 145. The retroreflective sheet 147 is disposed at 90° with respect to the display surface of the display device 145 in the direction of a displayed image reflected by the beam splitter 146. The display device 145, the beam splitter 146, and the retroreflective sheet 147 are examples of optical parts.

In the aerial image forming device 101D, light output from the display device 145 is reflected by the beam splitter toward the retroreflective sheet 147. The light is then reflected by the retroreflective sheet 147 and passes through the beam splitter 146, thereby forming an image in the air at a certain position. The aerial image 110 is thus formed at this position.

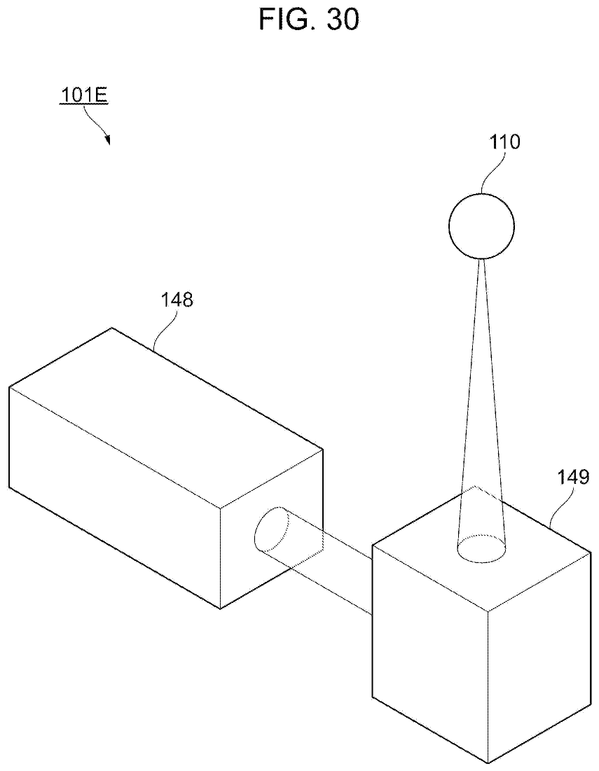

FIG. 30 is a view for explaining how an aerial image forming device 101E forms a set of plasma emitting members as an aerial image 110.

In the aerial image forming device 101E, an infrared pulse laser 148 outputs pulsating laser light, and an XYZ three-dimensional scanner 149 concentrates the pulsating laser light in the air. At this time, a gas in the vicinity of the focal point is momentarily formed into plasma and emits light. The pulse frequency is 100 Hz or lower, for example. The pulse emission time is on the order of nanoseconds, for example. The infrared pulse laser 148 and the XYZ three-dimensional scanner 149 are examples of optical parts.

### Tenth Exemplary Embodiment

A description will be given of a technology for assisting in printing an image displayed on the display surface 11 which is continuous by 360° at least in one direction.

According to the recent progress of display technologies, displaying of a 360°-continuous image by using a cylindrical display device or a spherical display device, for example, has been put to practical use. A camera for imaging a 360°-continuous image is also available. On the other hand, however, a technology for printing a 360°-continuous image on a sheet has not yet been put to practical use.

In a tenth exemplary embodiment, an image is displayed on a display device including a display surface which is continuous in a ring-like shape at least in one direction, as in the first exemplary embodiment. In the tenth exemplary embodiment, a technique for setting an edge portion for printing such an image will be discussed.

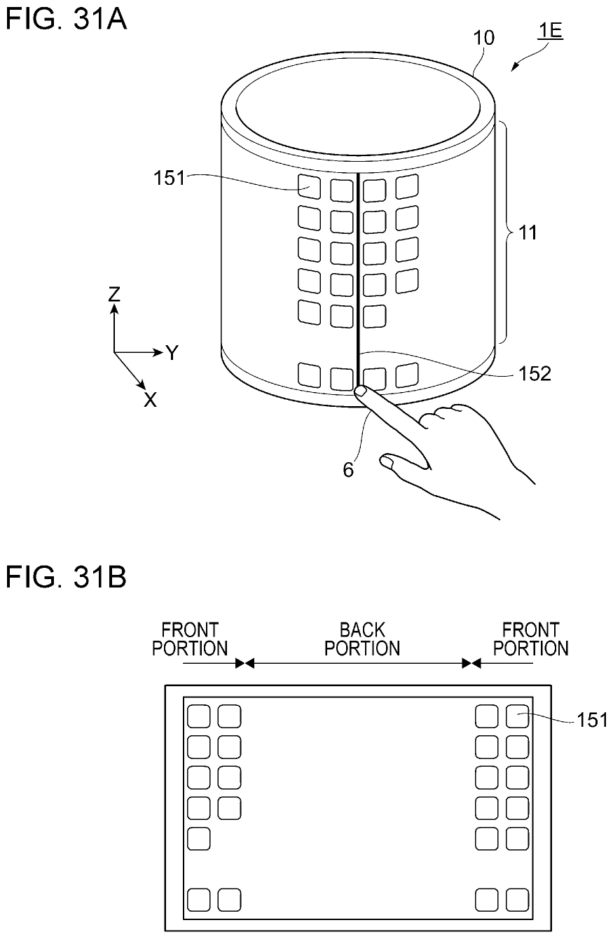

FIGS. 31A and 31B illustrate a technique for setting a print area on a 360°-continuous display surface according to the tenth exemplary embodiment. FIG. 31A illustrates an example of setting a print area on the cylindrical display surface 11. FIG. 31B illustrates a print result.

An information processing apparatus 1E shown in FIG. 31A is the same as the information processing apparatus 1 of the first exemplary embodiment (see FIGS. 1A and 1B).

In the tenth exemplary embodiment, as well as in the first exemplary embodiment, a user moves a fingertip 6 along the cylindrical display surface 11 to set a position.

In the tenth exemplary embodiment, however, the user moves the fingertip 6 to set an edge portion for printing the image displayed on the display surface 11. In FIG. 31A, the user moves the fingertip 6 vertically to set an edge portion 152.

In this case, the user may not be able to move the fingertip 6 straight and the top edge and the bottom edge may not be at the same position in the circumferential direction. In the information processing apparatus 1E of the tenth exemplary embodiment, a function of correcting the position of the edge portion 152 is provided so that the edge portion 152 can be perpendicular to the display surface 11.

In FIG. 31A, the edge portion 152 is set at a position where four columns of icons 151 are divided into halves. In the example in FIG. 31A, the print direction is set in advance so that printing will be performed counterclockwise from the edge portion 152. As a result of the user simply setting the edge portion 152, the print result shown in FIG. 31B is obtained.

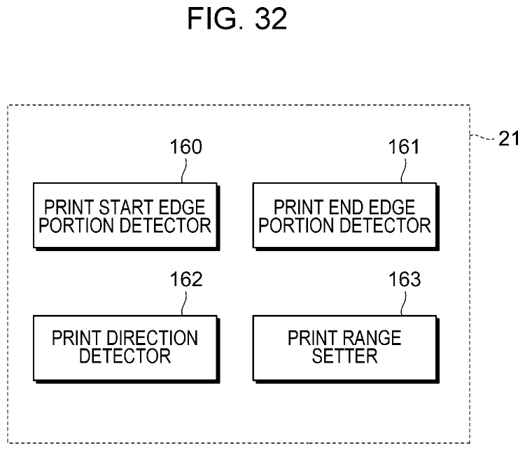

FIG. 32 illustrates examples of functions implemented as a result of the CPU 21 (see FIG. 2) executing a program. In the tenth exemplary embodiment, a function of receiving the setting of an edge portion for printing and a function of setting a print range are required.

To achieve these functions, the CPU 21 serves as a print start edge portion detector 160, a print end edge portion detector 161, a print direction detector 162, and a print range setter 163. The print start edge portion detector 160 detects the position of a print start edge portion. The print end edge portion detector 161 detects the position of a print end edge portion. The print direction detector 162 detects a direction in which printing will start from the detected print start edge portion. The print range setter 163 sets a print range based on the detected edge portions and direction.

If setting of one edge portion is detected, the print start edge portion detector 160 and the print end edge portion detector 161 set this edge portion as the print start edge portion and the print end edge portion. If setting of two edge portions is detected, the print start edge portion detector 160 sets the edge portion which has been set earlier as the print start edge portion, while the print end edge portion detector 161 sets the edge portion which has been set later as the print end edge portion.

The print direction detector 162 is a function to be executed when the print direction (clockwise or counterclockwise) has not been determined in advance. The print direction detector 162 detects whether the user has moved the fingertip 6 clockwise or counterclockwise.

If setting of one edge portion is detected, the print range setter 163 sets a print range starting from the detected edge portion in the predetermined direction or in the detected direction. If setting of two edge portions is detected, the print range setter 163 sets, as a print range, a range from the edge portion detected earlier to that detected later in the predetermined direction or in the detected direction. If the entirety of the outer edge forming a print area is set, the print range setter 163 sets the area defined by this outer edge as a print area.

One of or a combination of the print start edge portion detector 160, the print end edge portion detector 161, the print direction detector 162, and the print range setter 163 function as a receiver concerning a corresponding print function.

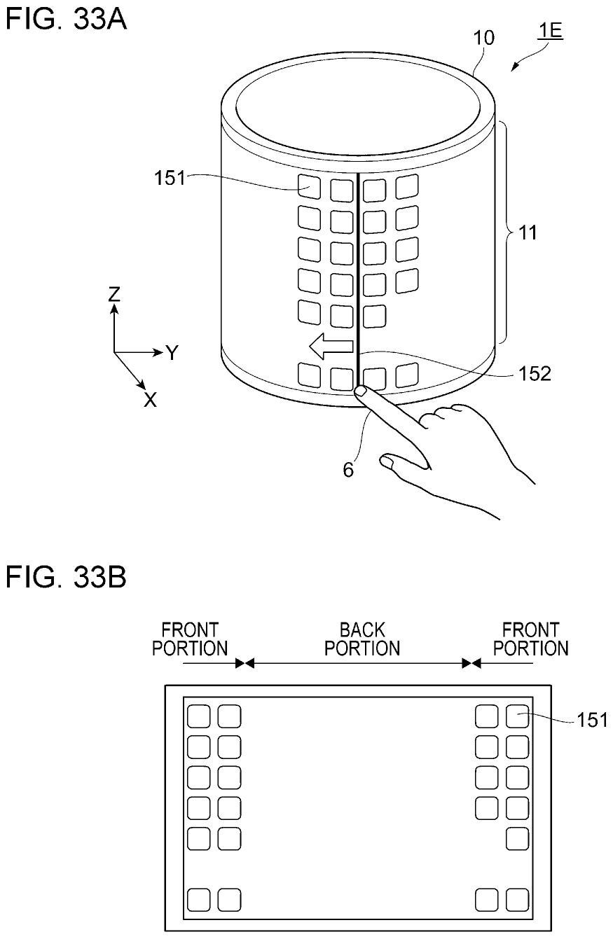

Examples of the execution of printing will be discussed below with reference to FIGS. 33A through 37B.

FIGS. 33A and 33B illustrate an example of the execution of printing when one edge portion 152 is set and the print direction is leftward (clockwise). FIG. 33A shows a user operation, and FIG. 33B shows a print result.

In the example in FIGS. 33A and 33B, information about the image is read from the edge portion 152 in the clockwise direction and is printed on a sheet.

If the user moves the fingertip 6 rightward (counterclockwise), the same print result as that shown in FIG. 31B is obtained.

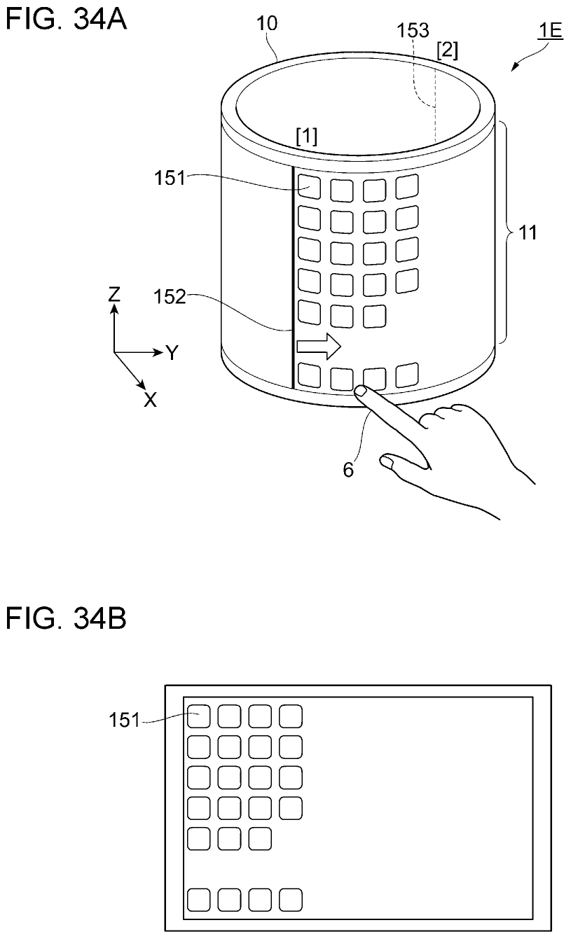

FIGS. 34A and 34B illustrate an example of the execution of printing when two edge portions 152 and 153 are set and the print direction is rightward (counterclockwise). FIG. 34A shows a user operation, and FIG. 34B shows a print result.

The print direction indicated by the arrow in FIG. 34A may be set before the setting of the end portions 152 and 153, or between the settings of the end portions 152 and 153, or after the setting of the end portions 152 and 153.

With the operation shown in FIG. 34A, only a certain portion of the image displayed around 360° can be printed.

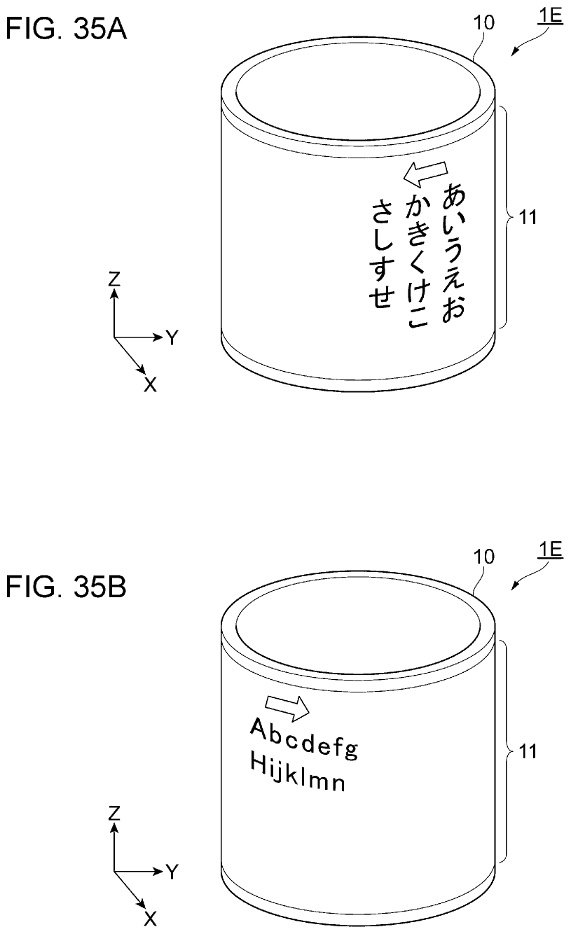

FIGS. 35A and 35B illustrate an example in which the print direction is automatically determined according to the content of a displayed image. FIG. 35A illustrates the print direction for vertically written characters. FIG. 35B illustrates the print direction for horizontally written characters.

In the case of an image showing vertical character strings, such as Kanji (Chinese characters) or Hiragana (Japanese characters), the clockwise direction is set as the print direction. In the case of an image showing horizontal character strings, such as roman characters or numeric characters, the counterclockwise direction is set as the print direction.

In the case of the 360°-continuous display surface 11, if plural areas forming the display surface 11 are distinguishable from each other from the physical shape of the display surface 11, a print range may be set by selecting areas for printing.

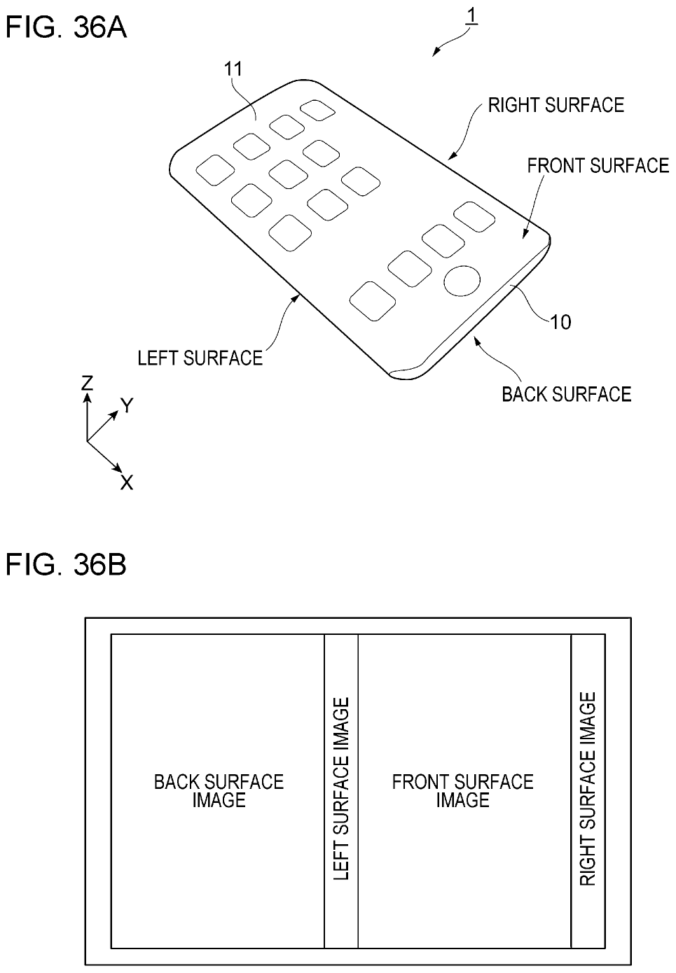

FIGS. 36A and 36B illustrate an example of the execution of printing when display areas of the display surface 11 are distinguishable from each other from the physical shape of the display surface 11. FIG. 36A shows examples of display areas, each of which is managed as the unit of printing. FIG. 36B shows a print result obtained when all the areas have been selected for printing.

The body 10 of the information processing apparatus 1 shown in FIG. 36A has a substantially flat shape. The display surface 11 is constituted by four areas, that is, a front surface, a back surface, a right surface, and a left surface, as units of printing. In the example in FIGS. 36A and 36B, all the four areas are selected for printing, and images in the four areas are thus printed at corresponding positions of a sheet, as shown in FIG. 36B.

The user can select an area to be printed by touching a specific part of the area with a finger. However, for a terminal held by a hand for use, such as a smartphone or a tablet, it is difficult to find whether the user is merely touching a certain portion on the display surface 11 to hold the terminal or the user has selected this portion to be printed.

Accordingly, if, among the four display surfaces, a predetermined portion (around the bottom edge, for example) is touched, it may be determined that this portion has been set for printing.

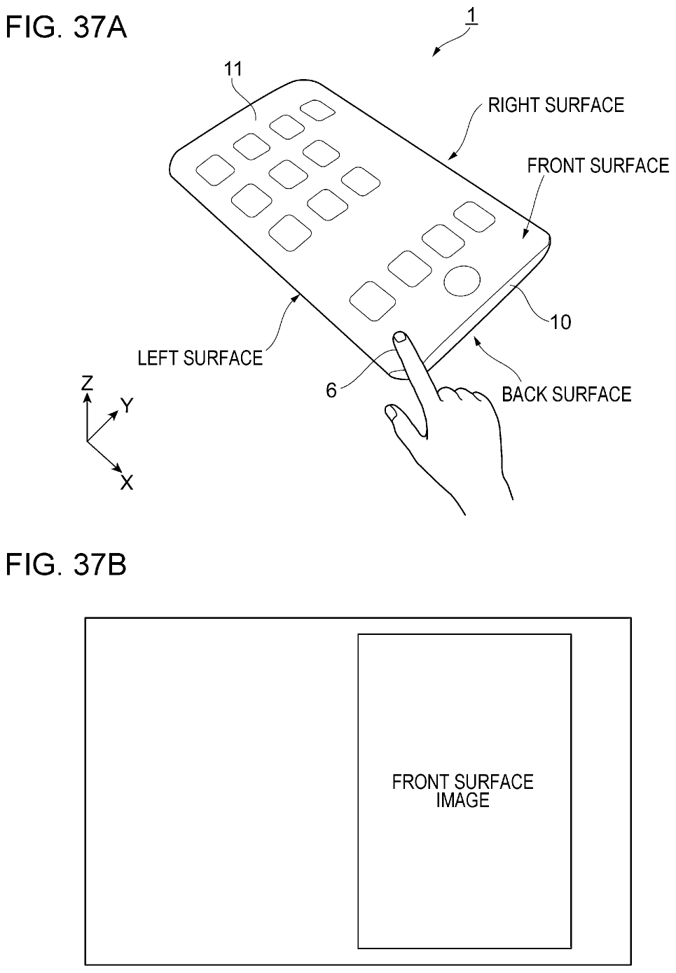

FIGS. 37A and 37B illustrate another example of the execution of printing when display areas of the display surface 11 are distinguishable from each other from the physical shape of the display surface 11. FIG. 37A shows examples of display areas, each of which is managed as the unit of printing. FIG. 37B shows a print result obtained when one area has been selected for printing.

In the example in FIGS. 37A and 37B, among the four areas (front surface, back surface, right surface, and left surface) managed as the units of printing on the display surface 11, the front surface is selected for printing. As a result, only the image on the front surface is printed, as shown in FIG. 37B.

As described above, in the tenth exemplary embodiment, the information processing apparatus 1 including the following receiver has been discussed. When an image is displayed all around the display surface 11 which is continuous by 360° at least in one direction, this receiver receives the setting of a position of an edge portion of an area to be printed.

The receiver has a function of receiving the setting of a print direction, that is, whether the image displayed on the display surface 11 will be printed clockwise or counterclockwise starting from the position of the edge portion. If the image displayed on the display surface 11 contains character strings, the receiver determines a print direction according to the written direction of the characters by using a certain function.

With these functions, the information processing apparatus 1 of the tenth exemplary embodiment is able to output a print result reflecting a layout desirable for a user even in a case in which an image is displayed all around the display surface 11 continuous by 360° at least in one direction.

### Other Exemplary Embodiments

The present disclosure has been discussed through illustration of the above-described exemplary embodiments. Various modifications and improvements may be made to the above-described exemplary embodiments.

For example, in the exemplary embodiments other than the seventh exemplary embodiment, the display surface and the CPU executing the functions are provided in the single information processing apparatus. However, the information processing apparatus may be implemented as an information processing system in which the display surface and the CPU are separately provided.

The foregoing description of the exemplary embodiments of the present disclosure has been provided for the purposes of illustration and description. It is not intended to be exhaustive or to limit the disclosure to the precise forms disclosed. Obviously, many modifications and variations will be apparent to practitioners skilled in the art. The embodiments were chosen and described in order to best explain the principles of the disclosure and its practical applications, thereby enabling others skilled in the art to understand the disclosure for various embodiments and with the various modifications as are suited to the particular use contemplated. It is intended that the scope of the disclosure be defined by the following claims and their equivalents.

What is claimed is:

1. An information processing apparatus comprising:
a switching unit that switches the entirety of a displayed image to another image when the content of a user instruction to shift the entirety of the displayed image satisfies a predetermined switching standard, a display position of the displayed image not being fixed; and
a receiver that receives setting of the switching standard.

2. The information processing apparatus according to claim 1, wherein the switching standard concerns a condition that a specific portion of an image displayed on a display surface crosses over a boundary in a predetermined direction, the boundary being set on the display surface.

3. The information processing apparatus according to claim 2, wherein the specific portion on the display surface and the predetermined direction are determined based on one or a plurality of the boundaries set on the display surface.

4. The information processing apparatus according to claim 2, wherein, if a plurality of the boundaries are set on the display surface, when a specific portion of an image displayed at a certain position with respect to one boundary has shifted to another boundary, the entirety of the image displayed on the display surface is switched to another image.

5. The information processing apparatus according to claim 2, wherein, if a plurality of the boundaries are set on the display surface, cyclic shifting and switching of the entirety of an image displayed in a region sandwiched between a pair of boundaries is controlled.

6. The information processing apparatus according to claim 2, wherein the boundary is set in each of a plurality of regions of the display surface.

7. The information processing apparatus according to claim 6, wherein positions of the boundaries set in the plurality of regions are different from each other.

8. The information processing apparatus according to claim 2, wherein the boundary is set for each image to be switched.

9. The information processing apparatus according to claim 1, wherein, if a display surface has a pair of end portions, the entirety of an image currently displayed on the display surface is switched to another image on condition that a portion of the image displayed at one end portion is shifted to the other end portion.

10. An information processing system comprising:
a switching unit that switches the entirety of a displayed image to another image when the content of a user instruction to shift the entirety of the displayed image satisfies a predetermined switching standard, a display position of the displayed image not being fixed;
a receiver that receives setting of the switching standard; and
a display that displays an image on a display surface.

11. A non-transitory computer readable medium storing a program causing a computer to execute a process, the process comprising:
switching the entirety of a displayed image to another image when the content of a user instruction to shift the entirety of the displayed image satisfies a predetermined switching standard, a display position of the displayed image not being fixed; and
receiving setting of the switching standard.
